(19) United States
(12) Patent Application Publication
(10) Pub. No.: US 2026/0189028 A1
(43) Pub. Date: Jul. 2, 2026

(54) SMART CHARGER

(71) Applicant: Opal Camera, Inc., Fullerton, CA (US)

(72) Inventors: Sudharshan Sundaramahalingam, Fullerton, CA (US); Veeraj Chugh, Fullerton, CA (US); Javier Sagastuy-Brena, Fullerton, CA (US); Suraj Menon, Fullerton, CA (US); Stefan Sohlstrom, Fullerton, CA (US)

(73) Assignee: Opal Camera, Inc., Fullerton, CA (US)

(21) Appl. No.: 19/382,017

(22) Filed: Nov. 6, 2025

Related U.S. Application Data
(60) Provisional application No. 63/723,351, filed on Nov. 21, 2024.

(51) Int. Cl. H02J 7/44; G06F 21/32; G06F 21/44; G06V 10/42

(52) U.S. Cl. CPC H02J 7/44; G06F 21/32; G06F 21/44; G06V 10/42

(57) ABSTRACT

In variants, the system can include a smart charger that includes: a user device connector; a control block with an accessory authentication chip, a media conversion chip, and a processing unit; a power system; an optional user authentication module; an optional mode switch; an optional external interface set; and an optional machine learning model.

### CROSS-REFERENCE TO RELATED APPLICATIONS

This application claims the benefit of U.S. Provisional Application No. 63/723,351 filed 21 Nov. 2024, which is incorporated in its entirety by this reference.

### TECHNICAL FIELD

This invention relates generally to the power provision field, and more specifically to a new and useful smart charger in the power provision field.

### BRIEF DESCRIPTION OF THE DRAWINGS

FIG. 1 is a schematic representation of an embodiment of the smart charger system.

FIG. 2 is a schematic representation of a variant of the smart charger system.

FIG. 3 is a schematic representation of a variant of the smart charger system.

FIG. 4 is a schematic representation of a variant of the method of operation.

FIG. 5 is a schematic representation of an embodiment of the method of operation.

FIG. 6 is a schematic representation of an illustrative example of the method of operation.

FIG. 7 is a schematic representation of a variant of the method of operation.

FIG. 8 is a schematic representation of a variant of the method of operation.

FIG. 9 is an illustrative example of an embodiment of the system.

FIG. 10A is an illustrative example of an embodiment of the smart charger.

FIG. 10B is an illustrative example of an embodiment of the smart charger.

FIG. 11 is an illustrative example of a variant of the smart charger.

FIG. 12 is an illustrative example of a variant of the smart charger.

FIG. 13 is an illustrative example of a variant of the system.

FIG. 14 is a schematic representation of an embodiment of the method.

### DETAILED DESCRIPTION OF THE INVENTION

The following description of the embodiments of the invention is not intended to limit the invention to these embodiments, but rather to enable any person skilled in the art to make and use this invention.

### 1. Overview

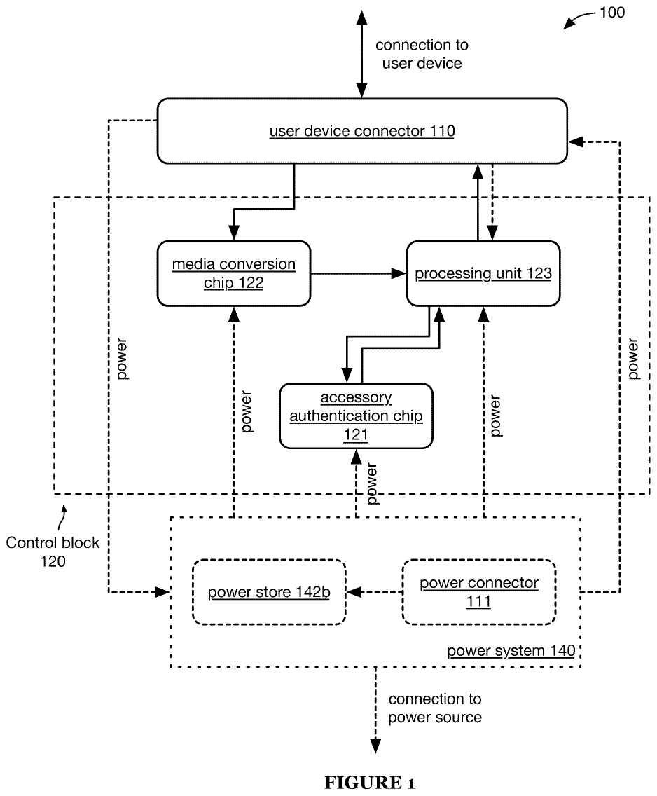

As shown in FIG. 1, variants of the smart charger can include: an user device connector 110; a control block 120; a power system 140; an optional user authentication module 150; an optional mode switch 160; an optional external interface set; and an optional machine learning model 180.

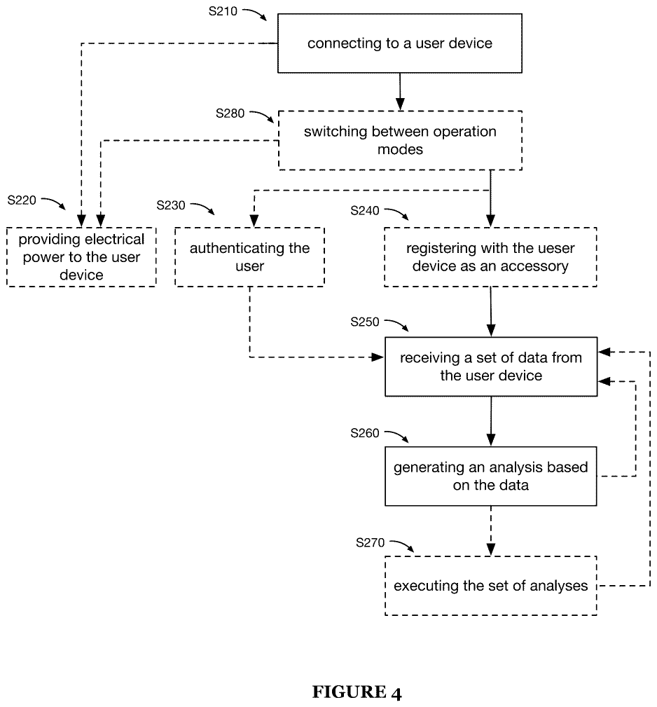

As shown in FIG. 4, variants of the method can include: connecting to a user device S210; providing electrical power to the user device S220; optionally authenticating the user S230; registering with the user device as an accessory S240; receiving a set of data from the user device S250; generating an analysis based on the set of data S260; optionally executing the set of analyses S270; and optionally switching between operation modes S280.

The smart charger and method of operation can function to enable automated cognitive analyses based on data passively determined from a user device.

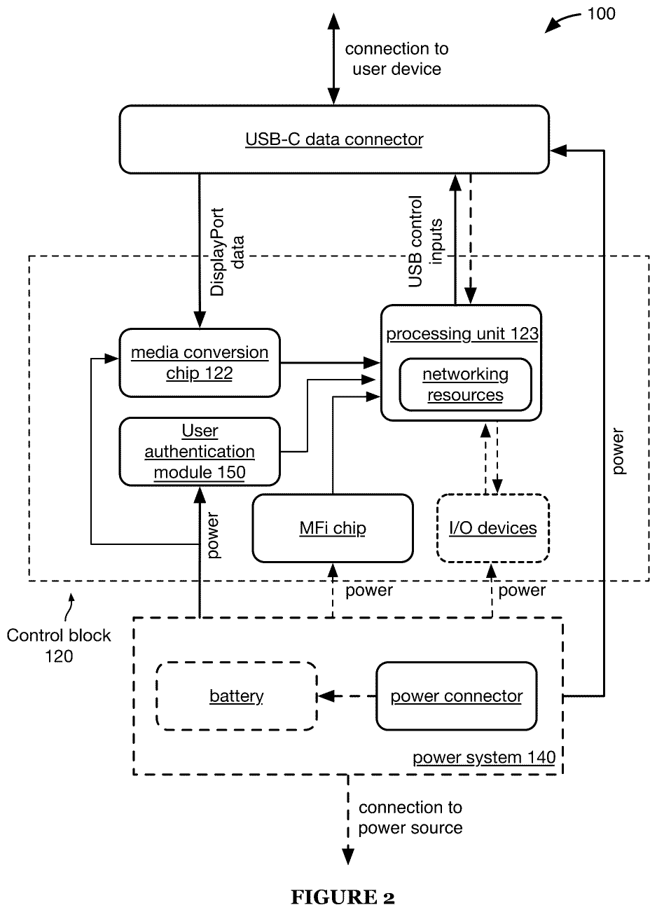

In an illustrative example, the smart charger can include: a control block with an accessory authentication chip (e.g., Mfi chip), a media conversion chip, and a processing unit; a user device connector wired to the control block; and a power supply mechanism wired to the control block. The power system powers the processing unit and chips in the control block while concurrently delivering power to a user device. An example is shown in FIG. 2.

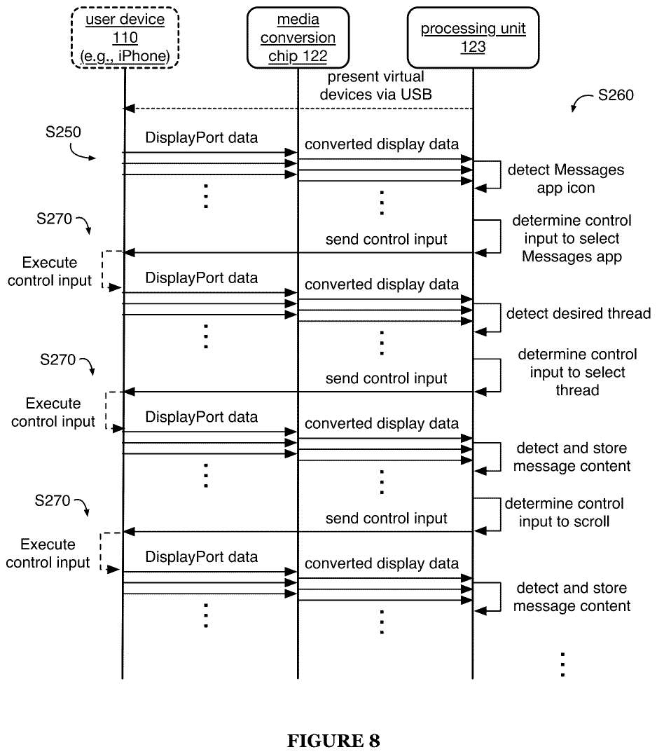

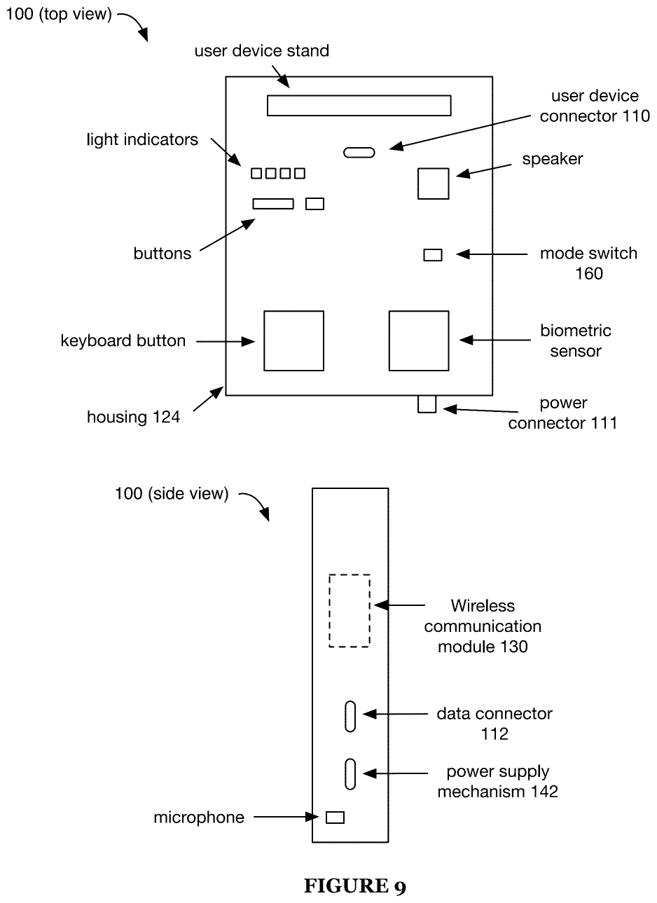

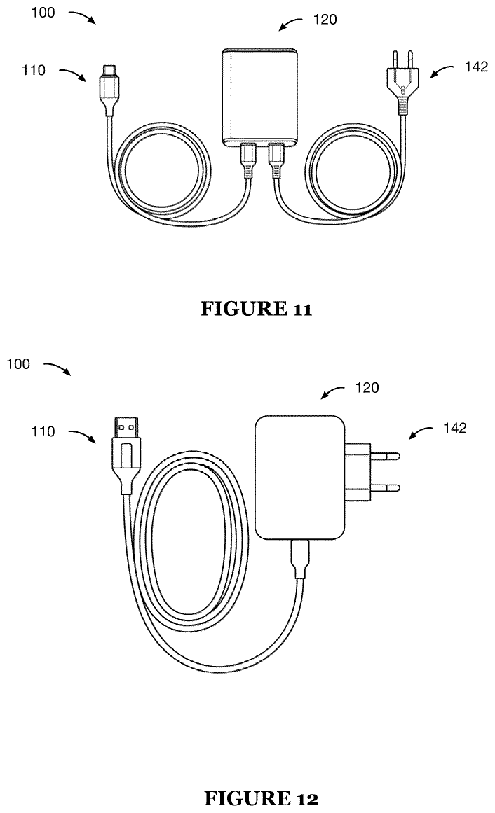

In a specific example, the system includes a USB-C connector (e.g., that provides a power and a data connection), an accessory authentication chip (e.g., Mfi chip), a display driver, a processing unit, and a power source (e.g., a power connector and/or a battery). The accessory authentication chip can register the charger as an I/O accessory (e.g., display, USB input device, etc.) with the user device (e.g., smartphone), which can enable the charger to read data off the user device and/or control the user device. The display driver can receive DisplayPort data (e.g., via the USB-C connector) optionally along with an audio output, convert the received DisplayPort data to a MIPI and/or LVDS format (e.g., single or multi-port), and provide the converted display data to the processing unit. The processing unit (e.g., single-board computer, such as Raspberry Pi) can receive display data from the display driver, facilitate task prediction based on the display data and/or other inputs (e.g., user commands, user profiles, etc.) using a machine learning model (e.g., locally or at a remote computing system), and implement the tasks by controlling the user device (e.g., by executing input gestures, such as swipes and keystrokes, on the user device). Examples are shown in FIG. 2, FIG. 9, and FIG. 11.

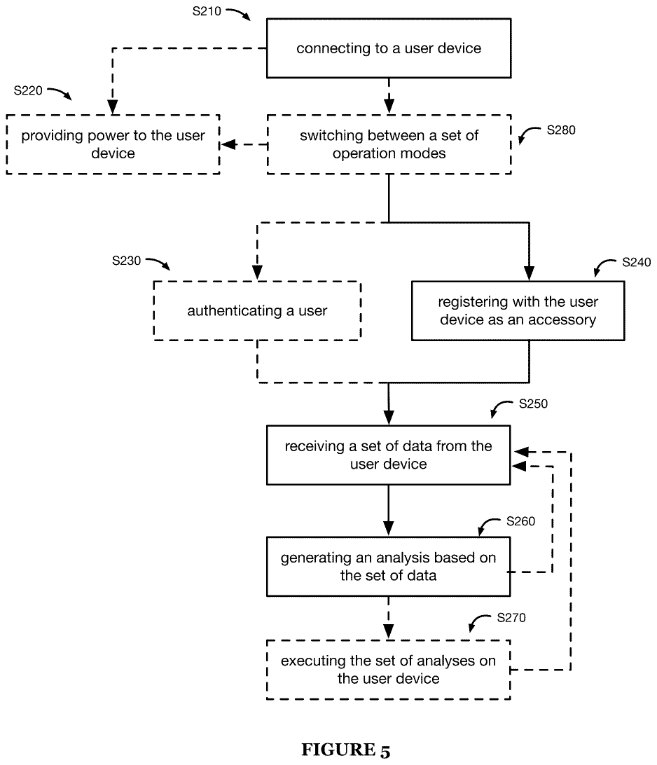

In an illustrative example, the method can include, at a smart charger, while powering a user device: registering with the user device as an accessory (e.g., using the accessory authentication chip; as an input device and/or output device); receiving a set of user device data (e.g., at the media conversion chip); generating a set of analyses based on the user device data (e.g., by an ML model executing locally or at a remote processing system) processing unit; and executing the set of analyses on the user device by controlling the user device through the accessory connection. An example is shown in FIG. 5.

However, the smart charger can be otherwise configured, and/or the method can be otherwise performed.

### 2. Technical Advantages

Variants of the technology can confer one or more advantages over conventional technologies.

First, variants of the technology can enable ML models and long-running processes to automatically interact with a user device while the user device is idle (e.g., not being actively used by the user), such as when the user device is charging. This can enable the ML models to access user data and/or interact with the user device without intruding on the user's experience. This can provide a passive, unintrusive mechanism for automatically learning user preferences, determining tasks, and controlling the user device to execute the tasks on behalf of the user without requiring explicit user input. For example, variants of the technology can automatically adjust device settings, perform maintenance tasks, respond to messages, sort user data, schedule meetings, book reservations, and/or perform other executive support functions. These responses can be further personalized by leveraging pre-established user behavior patterns (e.g., historical usage data, interaction sequences, temporal patterns), the system can intelligently infer user intent and automate operations. This approach can reduce the cognitive burden on users while improving device efficiency and user experience compared to conventional systems that require manual configuration or explicit user commands for each operation.

Second, variants of the technology can implement user authentication mechanisms that enhance security and privacy protection for the user. The authentication process can verify user identity through various methods (e.g., biometric verification, credential validation, behavioral authentication) before granting access to automated functions or sensitive operations. For example, the system can require authentication before executing high-privilege tasks or accessing user device data, thereby preventing unauthorized access or malicious exploitation of the automated capabilities. This security layer can provide protection against potential misuse while maintaining the convenience of automated task execution for verified users.

Third, variants of the technology can incorporate physical activation requirements for connecting hardware components to prevent accidental engagement of automated functions. By requiring deliberate physical interaction (e.g., button press, switch activation, connector insertion) to enable the automated system, unintended activation can be avoided. In a specific example, a physical switch or connector mechanism can serve as a hardware-based safety interlock that must be engaged before the system can begin automated operations. This physical activation requirement can provide an additional layer of control and can prevent inadvertent system activation due to software errors, environmental factors, or unintended user actions.

However, further advantages can be provided by the system and method disclosed herein.

### 3. System

As shown in FIG. 1, variants of the system includes: an user device connector 110; a control block 120; a power system 140; an optional user authentication module 150; an optional mode switch 160; an optional external interface set; and an optional machine learning model 180. The smart charger 100 can function to enable access to data from a user device and interactions with a set of ML models.

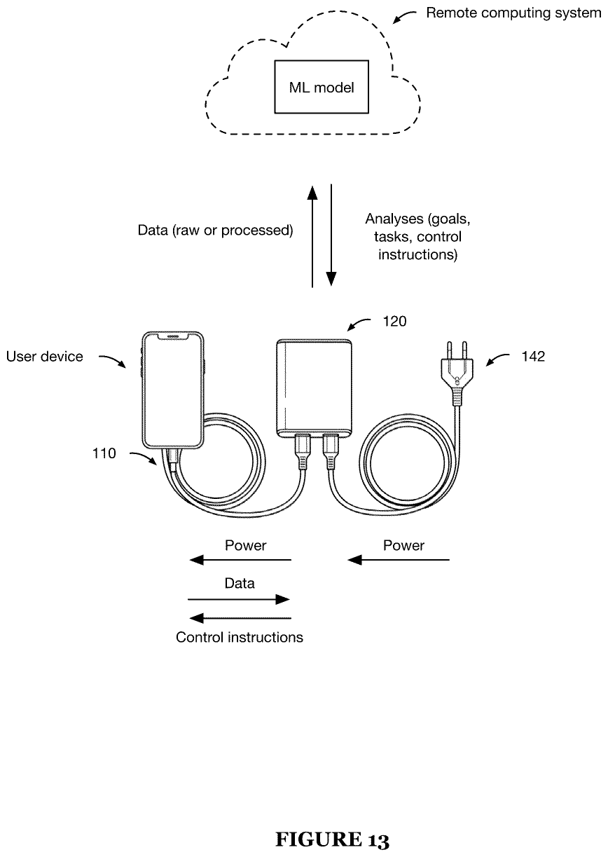

In variants, the smart charger 100 can passively access user data and/or execute tasks (e.g., predicted by the ML model) on behalf of the user through the user device, with no or minimal user intervention. An example is shown in FIG. 13.

In variants, the smart charger can be: a charging cable; a battery pack (e.g., a removable pack, a battery case, a power bank, etc.); and/or have any other form factor

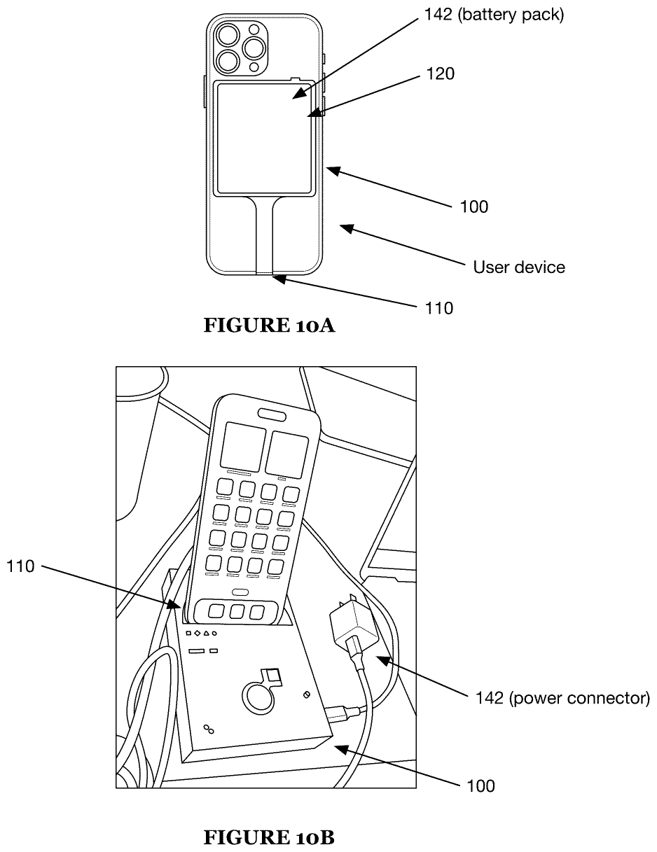

In a first example, the smart charger can be a battery case that couples to a section of the user device and includes a rigid user device connector that connects to the power and/or data port of the user device (e.g., example shown in FIG. 10A). In a second example, the smart charger can include a cable with a control block (e.g., examples shown in FIG. 11 and FIG. 12). In a third example, the smart charger can include a phone dock (e.g., example shown in FIG. 10B).

In variants, the smart charger can be operable between: a charging mode, wherein the smart charger provides power to the connected user device (e.g., and does not receive media from the user device); a media receipt mode, wherein the smart charger reads or otherwise receives data off the user device; an analysis generation mode, wherein the smart charger facilitates analysis generation (e.g., task prediction, analysis prediction, etc.) based on the data; a user device control mode, wherein the smart charger controls the user device based on the analyses; a cognitive mode (e.g., including the media receipt mode, analysis generation mode, user device control mode, and optionally the charging mode, etc.); and/or any other set of operation modes.

The smart charger can be operable in one or more of the aforementioned modes. In a first example, the smart charger can only operate in the cognitive mode and the charging mode. In a second example, the smart charger can operate in all of the aforementioned modes (e.g., independently or concurrently).

The smart charger can contemporaneously operate in one or more of the modes, asynchronously operate in each mode, and/or otherwise operate in any other number of modes. In an example, the smart charger can charge the user device while operating in the cognitive mode.

The user device connector 110 functions to connect to a user device. The user device connector 110 can provide power and/or data to the user device. The user device connector 110 can optionally receive data from the user device. In examples, user devices that can be used with the smart charger can include smartphones, tablets, laptops, computers, smart watches, and/or any other user device. The user device connector 110 preferably connects to the user interface port of the user device (e.g., power/data interface port, USB-C port, Lightning port, etc.), but can additionally or alternatively connect to the power port, data port, and/or any other user device port; connect to a wireless channel of the user device; and/or connect to any other user device interface. The system can include one or more user device connectors 110. In a first example, the system can include multiple physical user device connectors (e.g., two USB-C connectors extending from the user device side of the system). In a second example, the system can include a physical user device connector and a wireless user device connection (e.g., USB-C for data and induction for power, etc.). The user device connector 110 can be a data connector, a power connector, a multipurpose connector, and/or any other type of connector. The user device connector 110 can be a wired connector, wireless connector, and/or any other connector.

Examples of wired data connectors that can be used can include a USB connector (e.g., USB-C, USB-A), Thunderbolt, a DisplayPort connector, audio jacks, a dock, and/or any other suitable physical connector.

Examples of wireless data connectors that can be used can include wireless power connections (e.g., inductive coils, MagSafe, etc.), wireless communication connections (e.g., Bluetooth, Wi-Fi, NFC, etc.), and/or other wireless connections.

The user device connector 110 is preferably connected to the control block by a wired connection (e.g., a cable, a trace, a set of wires, etc.), but can additionally or alternatively be connected to the control block by a wired connection and/or otherwise connected to the control block. The user device connector 110 is preferably directly connected to the processing unit and/or chipsets (e.g., accessory authentication chip, media conversion chip, etc.) by a wired connection (e.g., a cable, a trace, a set of wires, etc.), but can additionally or alternatively be connected to the processing unit and/or chipsets by a wireless connection and/or otherwise connected to the processing unit and/or chipsets. The user device connector 110 can be directly (e.g., physically) connected to the power system or indirectly connected to the power system (e.g., through the control block). In a first example, the user device connector includes a set of wires that are directly electrically connected to the power system (e.g., to the power management system, to the power rectifier, etc.).

In a second example, the user device connector includes a set of wires that are connected to the processing unit within the control block, wherein the processing unit functions as a power relay from the power system to the user device connector.

However, the user device connector 110 may be otherwise configured.

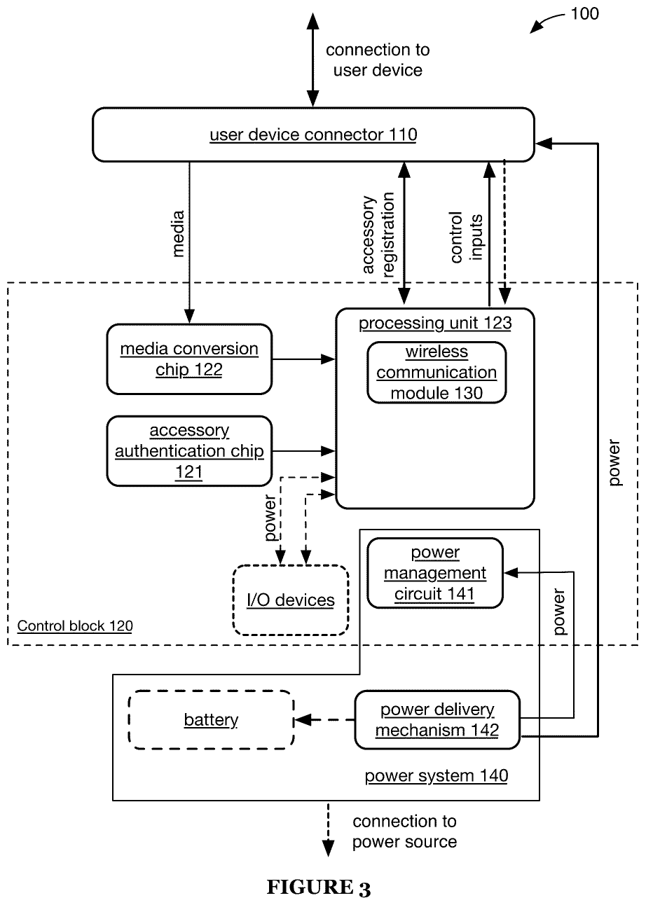

The control block 120 functions to house the control block components, register with the user device as an accessory, determine user data, facilitate ML-based analysis of the user data, and/or control the user device. An example is shown in FIG. 3. In examples, the control block components can include one or more: processing units, accessory authentication chips, media conversion chips, other chipsets, communication modules (e.g., wired communication modules, wireless communication modules, etc.), user interfaces (e.g., user inputs, user outputs, etc.), power management systems, and/or any other components. The control block 120 is preferably mechanically connected to the user device connector (e.g., by a set of wires), but can additionally or alternatively be wirelessly connected or otherwise connected. The control block 120 is preferably mechanically connected to the power system (e.g., by a set of wires, traces, etc.), but can additionally or alternatively be wirelessly connected or otherwise connected. The control block 120 is preferably arranged (e.g., mechanically, electrically, etc.) between the user device connector and the power system, but can alternatively be otherwise arranged. All or subsets of the control block 120 components can be powered by the power system, powered by an alternative power supply (e.g., an onboard battery, capacitors, etc.), and/or otherwise powered.

In variants, the control block 120 includes a housing 124; an accessory authentication chip 121; an optional media conversion chip 122; a processing unit 123; an optional wireless communication module 130, and/or other components.

The housing 124 functions to protect and mount control block components. The housing 124 can be prismatic, pyramidal, spherical, cylindrical, ellipsoidal, toroidal, and/or any other shape. The components can be mounted to the housing mechanically (e.g., fasteners, adhesives, etc.), be printed onto the housing, and/or otherwise be mounted. The housing 124 can include thermal management features or exclude thermal management features.

The thermal management features that can be used can include vents, heatsinks, heat spreaders, fans, casing materials (e.g., the housing functions as a heatsink), and/or any other thermal management features.

However, the housing 124 may be otherwise configured.

The accessory authentication chip 121 functions to register the smart charger as an accessory with the user device. The user device preferably functions as the client (e.g., sends display data, receives inputs, etc.), wherein the accessory functions as the host (e.g., provide the display surface or input control). Alternatively, the user device can function as the host, wherein the accessory functions as the client device. The smart charger can include one or more accessory authentication chips (e.g., of the same or different type). In an example, the smart charger can include an accessory authentication chip for iOS and a second accessory authentication chip for Android. The accessory authentication chip 121 can communicate with the user device through the user device connector or other wired connection, but can alternatively communicate with the user device through a wireless connection and/or any other connection.

The accessory authentication chip 121 can be arranged in the housing of the control block or otherwise arranged. In variants, the accessory authentication chip 121 can be mounted to the same board as the processing unit, be separate from the processing unit, be integrated into the processing unit, be integrated with and/or mounted with another chipset, and/or any other configuration.

The accessory authentication chip 121 is preferably electrically connected to and powered by the power system, but can additionally or alternatively be powered by the user device and/or otherwise powered. The accessory authentication chip 121 is preferably controlled by the processing unit, but can additionally or alternatively be otherwise controlled.

The accessory authentication chip 121 can be or include: a Made for iPhone/iPad/iPod (MFi) chip (e.g., configured to authenticate the smart charger as an accessory with an Apple or iOS device), USB authentication chips, HDCP authentication modules, trusted platform modules (TPMs), a HID (Human interface Device) chipset, the processing unit (e.g., running an HID protocol; provide a HID descriptor, such as a USB HID descriptor, HID service UUID, etc.), Bluetooth chips with accessory profiles including embedded keys, Google Fast Pair chips, Samsung Accessory Protocol chips, Subscriber Identity Module (SIM) technologies (e.g., embedded SIM, integrated SIM, etc.), and/or any other authentication chips. In an example, MFi modules can include the audio accessory module, lightning audio module, apple watch fast charger module, and/or any other module.

The accessory authentication chip 121 can optionally include secure elements. The secure elements can include a cryptographic identity chip and/or secure microcontrollers.

However, the accessory authentication chip 121 may be otherwise configured.

The system can optionally include a media conversion chip 122, which functions to convert user device data between media formats. In variants, the media conversion chip 122 can: expose a subset of the signals provided by the user device, handle timing and voltage requirements, ensure compliance with the user device specifications, and/or perform other functionalities. In an example, the media conversion chip can convert display information from a first format (wherein the information is received from a user device in the first format) and/or convert display information to a second format interpretable by one or more processing units of the system. In a specific example, the media conversion chip can translate between Apple's proprietary signaling/protocols and standard formats. In an example, the media conversion chip can convert digital audio from an iPhone format to I2S, S/PDIF, and/or analog audio for DACs. In an example, the media conversion chip can convert video outputs (e.g., via Lightning or USB-C) to HDMI, DisplayPort, or VGA for external displays.

In an example, the media conversion chip can convert USB data (used for input/output accessories) to UART/serial and/or any other interfaces the accessory MCU can use.

Examples of media conversion chips that can be used can include NXP 466x/846x chips, Cirrus Logic CS42L42 chips, Dialog DA1469x chips, Custom ASICs (e.g., proprietary AV/VGA adapter integrated circuits), Cirrus Logic codec (338S00140/ CS42L42 family) chips, and/or any other media conversion chips.

The smart charger can include one or more media conversion chips 122 (e.g., of the same or different type). In an example, the smart charger can include a media conversion chip for video and a second media conversion chip for audio, or include a single media conversion chip that handles multimedia. The media conversion chip 122 can communicate with the user device through the user device connector or other wired connection, but can alternatively communicate with the user device through a wireless connection and/or any other connection.

In a variant, the media conversion chip 122 can receive data from a user device, process the data, and send signals to a processing unit, a display driver, and/or to any other data endpoint.

The media conversion chip 122 can be arranged in the housing of the control block or otherwise arranged. In variants, the media conversion chip 122 can be mounted to the same board as the processing unit, be separate from the processing unit, be integrated into the processing unit, be integrated with and/or mounted with another chipset, and/or any other configuration. The media conversion chip 122 is preferably electrically connected to and powered by the power system, but can additionally or alternatively be powered by the user device and/or otherwise powered. The media conversion chip 122 is preferably controlled by the processing unit, but can additionally or alternatively be otherwise controlled. In a first example, the media conversion chip can receive display information in a DisplayPort format (e.g., DP1.4a), an HDMI format (e.g., HDMI2.1), and/or in any other suitable formats. In a second example, the media conversion chip can additionally and/or alternatively convert the received display information to a Mobile Industry Processing unit Interface (MIPI) format (e.g., MIPI-DSI), to a low-voltage differential signaling (LVDS) format (e.g., FPD-Link), and/or to any other suitable formats. In a third example, the media conversion chip can optionally convert audio information received with the display information (e.g., audio information from an audiovisual information format) to an audio output (e.g., separate audio output format, audiovisual output format, etc.). In a specific example, the smart charger includes a media conversion chip (e.g., Lontium brand display driver) that converts display information from DP1.4a and/or HDMI2.1 to MIPI and/or LVDS (e.g., to a multi-port MIPI and/or LVDS output, such as a dual-or quad-port output), optionally with a separate audio output. However, the system can additionally or alternatively include any other suitable media conversion chips.

However, the media conversion chip 122 may be otherwise configured.

The processing unit 123 functions to obtain data from the user device, determine control inputs to provide to the user device, control the user device, store user profiles, and/or perform any other functions. The processing unit 123 can optionally store and/or execute a set of ML models (e.g., weights, biases, parameters, etc.) for analysis generation. The ML model(s) can be a DNN, CNN, RNN, diffusion model, transformer, GAN, and/or any other ML model. The ML model(s) can be: a generalized model (e.g., trained on a plurality of user data); a user-specific model (e.g., trained on the user's data); and/or be otherwise trained. The processing unit 123 can include one or more: processors, memory and/or storage elements, USB interfaces (e.g., USB hubs and/or emulators thereof), networking resources (e.g., wireless networking resources, such as Bluetooth, Wi-Fi, and/or mobile network communication modules, wired networking resources, etc.), and/or any other suitable computing components. In one example, the processing unit 123 can include one or more embedded computer systems, such as a single-board computer (e.g., Raspberry Pi), system-on-chip, system-in-package, computer-on-module, ASIC, FPGA, and/or any other embedded computer systems. The processing unit 123 can additionally or alternatively include memory (e.g., RAM, ROM, Flash, etc.).

The processing unit can register the charger with a user device as an accessory using the accessory authentication chip, optionally authenticate a user identity (e.g., by comparing user inputs to stored keys, verifying the user device identity, verifying user biometrics, verifying user credentials, etc.), receive user device media from the user device after registration, determine analyses based on the user device media (e.g., predict the analysis using a local ML model, coordinate analysis prediction with a remote computing system, etc.), control the user device according to the analyses, optionally store user data (e.g., a user profile, user device data, network data, etc.), optionally manage power provision to the user device (e.g., battery management, voltage monitoring, providing power to components, temperature monitoring, etc.), and/or perform any other function. The processing unit can control the user device by simulating a user input (e.g., swipe acceleration, click, keystroke, etc.).

The processing unit 123 can be arranged in the housing of the control block, on a surface of the control block housing, and/or otherwise arranged. The processing unit 123 can be electrically and/or communicatively connected to the accessory authentication chip, the media conversion chip, wireless communication systems, the power systems, optional input/output devices, the user device connector, and/or any other components. The processing unit 123 is preferably electrically connected to and powered by the power system, but can additionally or alternatively be powered by the user device and/or otherwise powered. The processing unit 123 is preferably electrically and/or communicatively connected to the user device by the user device connector, but can additionally or alternatively be connected to the user device by any other connection (e.g., wired or wireless connection). The processing unit 123 can be connected to the user device by one or more connections. In an example, the connection can establish multiple connections with the user device for different media types, for data and power, and/or any other purpose.

However, the processing unit 123 may be otherwise configured.

The smart charger can optionally include a wireless communication module 130, which functions to transmit and/or receive data with one or more devices. The wireless communication module 130 can function as a redundant data and/or power connection (e.g., establish a secondary communication channel with the user device). The wireless communication module 130 can connect the smart charger (e.g., the processing unit, accessory authentication chip, etc.) to the user device, to a peripheral device (e.g., a smart home device, an accessory), and/or any other endpoint. The wireless communication module 130 can additionally and/or alternatively pre-process the received data, but can alternatively not pre-process the data. In an example, the preprocessing can convert signals from digital-to-analog (e.g., using a digital-to-analog converter (DAC)), amplify signals, filter signals, and/or otherwise process signals. The smart charger can include one or more wireless communication modules 130 (e.g., a set of wireless communication modules) of the same or different type. In an example, the wireless communication modules can include a Bluetooth module, BLE module, NFC module, inductive charging module, and/or any other module. Each wireless communication module 130 can support one or more communication protocols. The wireless communication module 130 set can be arranged in the housing of the control block, and/or otherwise arranged.

The wireless communication module 130 can include an antenna and/or a chip set. The antenna can be a planar coil, a closed wire loop, a ferrite-backed loop, a monopole antenna, an inverted-F, meandered dipole, a printed antenna, slot antenna, and/or any other antenna.

The chip set can include an RF transceiver, a subscriber identity module (SIM) subsystem, an electronic SIM subsystem, amplifiers (e.g., low-noise amplifiers, pre-amplifiers, etc.), filters, communication protocol interfaces, CPU core, digital signal processor, memory, digital-to-analog converter, analog-to-digital converters, pre-amplifiers, sensor interfaces, and/or any other chip component.

The antenna and chip set can be mounted to different surfaces in the housing. In an example, an antenna can be mounted in the back section and be electronically coupled to a communication chip in the front section of the housing. In a specific example, an NFC coil can be mounted to the back section and be electronically coupled to a communication chip in the front section of the housing. The wireless communication module 130 is preferably electrically connected to and powered by the power system, but can additionally or alternatively be powered by the user device and/or otherwise powered. The wireless communication module 130 is preferably controlled by the processing unit, but can additionally or alternatively be otherwise controlled. Data received by the wireless communication module 130 from an external device is preferably sent to the processing unit, but can alternatively be sent to any other endpoint.

The wireless communication module can support Bluetooth classic, Bluetooth Low Energy (BLE), Wi-Fi Direct, Ultra-Wideband (UWB), cellular (e.g., LTE Direct, 5G sidelink), line-of-sight (e.g., infrared), and/or any other protocol.

However, the wireless communication module 130 may be otherwise configured.

However, the control block 120 may be otherwise configured.

The power system 140 functions to deliver electrical power to the control block and/or user device.

The power system 140 can power the control block (e.g., the power management circuit, to the processing unit(s), to the chipsets, etc.), the user device, and/or any other component.

The power system 140 can provide power to different endpoints in serial, parallel, and/or with other configuration. The power system 140 can power one endpoint without powering the others. In an example, the power system can charge the user device without powering the control block.

The power delivery mechanism can include wall power, power connectors (e.g., a USB-C connector), a power store (e.g., battery), power generators (e.g., a photovoltaic cell, etc.), and/or any other power delivery mechanism.

In variants, the power system 140 includes a power management circuit 141 and a power delivery mechanism 142.

The power management circuit 141 functions to handle voltage regulation, power distribution to the user device and/or components of the system (e.g., the accessory authentication chip, the media conversion chip, the wireless communication set, the battery, input/output devices, etc.), power conversion (e.g., AC to DC to the battery), battery management, low-power modes, and protection (e.g., over-current, over-voltage, thermal, etc.), and/or any other functions. The power management circuit 141 can include an integrated circuit (e.g., ASIC, chipset, FPGA, etc.), and/or be otherwise implemented. The power management circuit 141 can be part of the processing unit or be a separate chipset. The power management circuit 141 can include thermal management logic circuits (e.g., controlling batteries, charging circuits, power delivery, regulation, etc.).

In a first variant, the power management circuit 141 can be located within the control block.

In a second variant, the power management circuit 141 can be located in a separate power block (e.g., a separate power adapter, etc.).

However, the power management circuit 141 can be otherwise arranged.

However, the power management circuit 141 may be otherwise configured.

The power delivery mechanism 142 functions to provide electrical power. The power delivery mechanism 142 can optionally store power. The power delivery mechanism 142 can alternatively receive power (e.g., from a user device) via the user device connector.

In a first variant, the power delivery mechanism 142 can be a power connector that plugs into a power supply.

Examples of the power connector that can be user include: a wall plug (e.g., two pronged plug, 3-pronged plug, etc.), a USB-C connector, and/or any other power connector.

The power supply can be a power outlet (e.g., grid-connected power outlet, battery, etc.), and/or any other power source. The power connector can be integrated into the control block or power adapter (e.g., direct plug-in), connected to the control block by a cable (e.g., in-line), or otherwise connected to the control block. The power connector is preferably different from the user device connector, but can alternatively be the user device connector (e.g., the user device powers the smart charger).

In a second variant, the power delivery mechanism 142 includes a set of batteries. The set of batteries can be arranged in the control block, in the power adapter, and/or in any other location.

However, the power delivery mechanism 142 may be otherwise configured.

However, the power system 140 may be otherwise configured.

The system can optionally include a user authentication module 150, which functions to authenticate the identity of a user.

The user authentication can be used to determine which mode to operate in, select the user profile to use for analysis generation, and/or any other function. The user authentication can determine which mode to operate in wherein, in an example, the smart charger operates in the cognitive mode when the user has been authenticated, and operates in the charging mode when the user has not been authenticated. The user authentication can select the user profile to use for analysis generation wherein the smart charger can select the user profile (e.g., history, preferences, etc.) associated with the authenticated user for use when predicting analyses (e.g., as a RAG database, as an input to the model, etc.).

The user authentication module 150 can be part of the processing unit, a separate chipset, be part of the user device, and/or be otherwise configured.

The user authentication module can be arranged on the user device connector (e.g., wherein the user is authenticated when the user holds the user device connector while connecting to the user device), the control block, the power adapter, the cable, and/or any other location.

The user authentication module 150 can include a set of sensors, a set of stored credentials, and/or any other components. The set of sensors can include biometric sensors, behavioral sensors, and/or any other sensors. The biometric sensors can include a fingerprint sensor, a retina sensor, an optical sensor (e.g., camera), and/or any other biometric sensors. The behavioral sensors can include a microphone (e.g., for voice recognition), ultrasonic sensors (e.g., for ultrasonic voice recognition, etc.), and/or any other behavioral sensors. The set of stored credentials can include knowledge-based credentials (e.g., password, pin, pattern lock, security question, etc.), hardware authentication credentials (e.g., a hardware token held by the user or by the user device), biometric credentials (e.g., a hash of a biometric measurement, the biometric measurement values, etc.), device-based credentials, and/or any other stored credentials. The device-based credentials can include device certificates or PKI (e.g., the user device proves its identity using cryptographic keys or certificates issued by the smart charger), device identifiers stored by the smart charger (e.g., MAC address, etc.), mobile device management enrollment, and/or any other device-based credentials.

However, the user authentication module 150 may be otherwise configured.

The system can optionally include a mode switch 160, which functions to switch the smart charger between operation modes. In an example, a first switch position places the smart charger in the cognitive and charging mode, and a second switch position places the smart charger in the charging mode only (e.g., and not the cognitive mode). An optional third switch position places the smart charger in the cognitive mode only (e.g., and not the charging mode). The mode switch 160 is preferably a physical switch (e.g., mechanical actuation, contact mechanism, etc.), but can alternatively be a digital switch. The mode switch 160 can be a single pole/single throw (SPST); single pole/double throw (SPDT); double pole/single throw (DPST); double pole/double throw (DPDT); toggle switch; rocker switch; push button; slider switch; rotary switch; and/or any other switch. The smart charger can include one or more mode switches 160 of the same or different type (e.g., to perform different functionalities, turn different modes on or off, etc.). The mode switch 160 can be located on: the user device connector, the cable between the user device connector and the control block, the control block, the cable between the control block and the power connector, the power connector, and/or any other location. The mode switch 160 can be electrically connected to the processing unit, the power management circuit, and/or any other circuits. In an example, the mode switch can be serially connected between the processing unit and the user device connector, wherein the power management circuit can be connected to the user device connector by a parallel circuit, and the mode switch disconnects the processing unit when in the second switch position.

However, the mode switch 160 may be otherwise configured.

The system can optionally include an external interface set, which functions to interface with a user and/or with the ambient environment. The external interface set can be arranged on the control block (e.g., on the surface of the housing of the control block, inside the housing of the control block, on a surface of the user device connector, etc.), on the power adapter, on the cable(s), on the connector(s), and/or any other components. The external interface set is preferably electrically connected to and powered by the power system, but can additionally or alternatively be powered by the user device and/or otherwise powered. The external interface set is preferably controlled by the processing unit, but can additionally or alternatively be otherwise controlled.

The external interface set can include user output and input devices. The user output can include displays, speakers, and actuators. The actuators can include motors, piezoelectric actuator, linear resonant actuator (LRA), and/or any other actuator. The input devices can include sensors, user inputs, and/or other input devices. The sensors can include camera (for facial recognition), microphone, thermometer, force sensor, accelerometer, and/or any other sensor. The user inputs can include keyboard, mouse, stylus, touchpad, touchscreen, and/or any other user input.

The smart charger can include or exclude one or more of the aforementioned external interfaces. In a specific example, the smart charger does not include (e.g., excludes) a display (e.g., a screen), but can include indicators (e.g., lights), examples shown in FIG. 9 and FIG. 10B. In another specific example, the smart charger does not include a user input (e.g., lacks a keyboard, mouse, touchscreen, etc.). In another specific example, the smart charger does not include any external interfaces. In another specific example, the smart charger only includes a set of sensors, and does not include user inputs or user outputs. However, the external interface set can additionally or alternatively include any other suitable human interface devices and/or any other suitable I/O devices.

However, the external interface set may be otherwise configured.

The system can optionally include a machine learning model 180, which functions to generate analyses. The system can use one or more machine learning models 180. In an example, the system can include a set of agents that cooperatively execute an agentic workflow.

The machine learning model 180 can generate analyses based on user data (e.g., received from the user device), user inputs (e.g., received from the user), ambient sensor data, external sources (e.g., weather sources), and/or any other data source. The user data can include visual data from the user device (e.g., screenshots, screen recordings, video), audio data from the user device (e.g., phone call data, music streams), application data (e.g., calendar data, food ordering service data, car service data, social media data), user profiles and/or preferences (e.g., automatically generated from other user data, received from the user), smartphone backups, contacts, location, messages, call logs, sensor data, file system contents, and/or any other user data.

The machine learning model 180 analyses can include generating a user profile, interpreting the user data, predicting a response, predicting a goal, predicting a set of tasks, and/or any other analysis.

Generating a user profile can include predicting a summary of the user based on the newly-received and/or past user data and embedding the user data into a latent space. The user profile can be generated for the user that owns the user device, auxiliary users that the user communicates with, and/or any other user.

Interpreting the user data can include: detecting a predetermined set of objects (e.g., application icons, buttons, etc.) in a screenshot and detecting a predetermined set of strings (e.g., words) in a screenshot.

Predicting a response can include predicting the response based on the most recent communication in the message thread and optionally the user profile (e.g., historical data on how the user has responded in the past) and predicting a text response, generating a synthetic voice response, and/or any other response prediction.

Predicting a goal can include predicting based on data from a predetermined set of applications (e.g., messaging applications, calendar applications, etc.) and optionally the user profile (e.g., historical data on user goals for similar calendar events or calls to action in the messaging thread). In an example, this can include predicting that a reservation should be made for a planned dinner and predicting the parameters for the reservation (e.g., location, time, etc.) based on user dining preferences, food restrictions, and/or other user profile parameters. The goals can be predicted using a goal prediction model (e.g., ML model, DNN, transformer, etc.), and/or otherwise determined.

Predicting a set of tasks (e.g., to achieve the goal) can include predicting based on a goal, a set of user device capabilities (e.g., available applications, available gestures or actions; etc.), user data, and/or other information and tasks. The tasks can be predicted using a task prediction model (e.g., ML model, DNN, transformer, etc.), and/or otherwise determined. The task prediction model(s) can be the same model as the goal prediction model, be a different instance of the same model as the goal prediction model, be a different model (e.g., different architecture, different training set, etc.), and/or be otherwise related to the goal prediction model.

Tasks can also include or be associated with a set of control inputs wherein execution of the control input set can implement the task.

A task can include an API call (e.g., (e.g., call to an application on the user device; call to a third party resource; etc.), a sub-goal (e.g., “determine attendees”, “determine food restrictions for attendees”, “call a restaurant”, “book a camping trip”; etc.), and/or other tasks (e.g., that reflect user intent).

A control input can include: a target-gesture pair (e.g., a start and/or stop screen coordinate and a gesture type; an application identifier and gesture type; etc.), an input event, a control signal, an interaction primitive (e.g., atomic user-system input, etc.), and/or be otherwise defined. Examples of gestures can include: swipe, click, and/or other gestures. The targets (e.g., screen coordinates) can be determined by a feature extractor (e.g., object detector, computer vision model, CNN, etc.) based on the user device data (e.g., screenshots, etc.), be determined from a map or capability graph provided by the user device, and/or be otherwise determined. Control inputs can be composable to achieve a higher level task (e.g., task, goal, etc.). Control inputs can include a set of parameters, such as location, direction, duration, trajectory, and/or other parameters. Examples of control inputs can include: touchscreen inputs (e.g., tap, double tap, long press, swipe, pinch), keyboard inputs (e.g., key down, key up, enter, specific key or letter, etc.), voice inputs (e.g., predetermined command utterances, etc.), mouse inputs (e.g., click, drag, scroll, etc.), and/or other control inputs. The control inputs can be predicted using a control input prediction model (e.g., ML model, DNN, transformer, etc.), and/or otherwise determined. In an example, the set of control inputs are predicted by a transformer model based on the task and the data (e.g., a screenshot of the user device, etc.). The control input prediction model(s) can be the same model as the task prediction model, be a different instance of the same model as the task prediction model, be a different model (e.g., different architecture, different training set, etc.), and/or be otherwise related to the task prediction model

The set of tasks can be performed serially (e.g., have parent-child task dependencies; include a set of serial tasks; etc.) or in parallel. The set of tasks can collectively achieve a goal (e.g., “plan a dinner”), be individual goals, and/or be otherwise related to a goal.

The models that can be used include DNN, CNN, RNN, GAN, transformer models, diffusion models, object detection models, OCR models, and/or any other models. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of attention layers (e.g., cross-attention layers, self-attention layers, etc.); and/or have any other suitable architecture. The models can include less than 10, tens, hundreds, thousands, tens of thousands, hundreds of thousands, and/or any other number of parameters (e.g., weights, biases, etc.). The models can extract data features (e.g., feature values, feature vectors, high-dimensional features, embeddings in a high-dimensional space with hundreds or thousands of dimensions, human-unintelligible features, etc.) from the input data, and determine the output based on the extracted features. However, the models can otherwise determine the output based on the input data.

Models can be trained, learned, fit, predetermined, and/or can be otherwise determined. The models can be trained or learned using: supervised learning, unsupervised learning, self-supervised learning, semi-supervised learning (e.g., positive-unlabeled learning), reinforcement learning, transfer learning, Bayesian optimization, fitting, interpolation and/or approximation (e.g., using gaussian processes), backpropagation, and/or otherwise generated. The models can be learned or trained on: labeled data (e.g., data labeled with the target label), unlabeled data, positive training sets (e.g., a set of data with true positive labels, negative training sets (e.g., a set of data with true negative labels), and/or any other suitable set of data.

Any model can optionally be validated, verified, reinforced, calibrated, or otherwise updated based on newly received, up-to-date measurements; past measurements recorded during the operating session; historic measurements recorded during past operating sessions; or be updated based on any other suitable data.

Any model can optionally be run or updated: once; at a predetermined frequency; every time the method is performed; every time an unanticipated measurement value is received; or at any other suitable frequency. Any model can optionally be run or updated: in response to determination of an actual result differing from an expected result; or at any other suitable frequency. Any model can optionally be run or updated concurrently with one or more other models, serially, at varying frequencies, or at any other suitable time.

The machine learning model 180 can be generalized, be specific to the user (e.g., trained on the user data, tuned on the user data, etc.), and/or be otherwise trained. The machine learning model 180 can run on: the smart charger (e.g., the processing unit, a dedicated chipset, etc.); a remote computing system; and/or any other compute. When the ML model runs on the remote computing system, the smart charger can send the data (e.g., user data, etc.) to the remote computing system and/or receive analyses from: the remote computing system via the user device (e.g., via the user device connector), another connected device, directly (e.g., through an internet connection established by the smart charger), and/or another communication channel. In an example, the charger can connect to the internet (e.g., the remote computing system) through the user device and/or other connected device (e.g., through a USB connection, secondary wireless connection, etc.). The machine learning model 180 can be a proprietary ML model, a ML model provided by a third party provider (e.g., OpenAI, Anthropic, etc.), and/or be any other model.

However, the machine learning model 180 may be otherwise configured.

### 4. Method

As shown in FIG. 4, the method can include: connecting to a user device S210; providing electrical power to the user device S220; optionally authenticating the user S230; registering with the user device as an accessory S240; receiving a set of data from the user device S250; generating an analysis based on the set of data S260; optionally executing the set of analyses S270; and optionally switching between operation modes S280. The method functions to provide passive automated cognitive analyses.

The method can be performed when a user device is connected to the smart charger, while the user device is connected to the smart charger (e.g., plugged in, wirelessly connected, etc.), when the mode switch is toggled to a predetermined position, while the user device is in a predetermined state (e.g., awake state, sleep state, etc.), and/or with any other timing or condition. All or portions of the method can be performed in real time (e.g., responsive to a request), iteratively, concurrently, asynchronously, periodically, and/or at any other suitable time. All or portions of the method can be performed automatically, manually, semi-automatically, and/or otherwise performed.

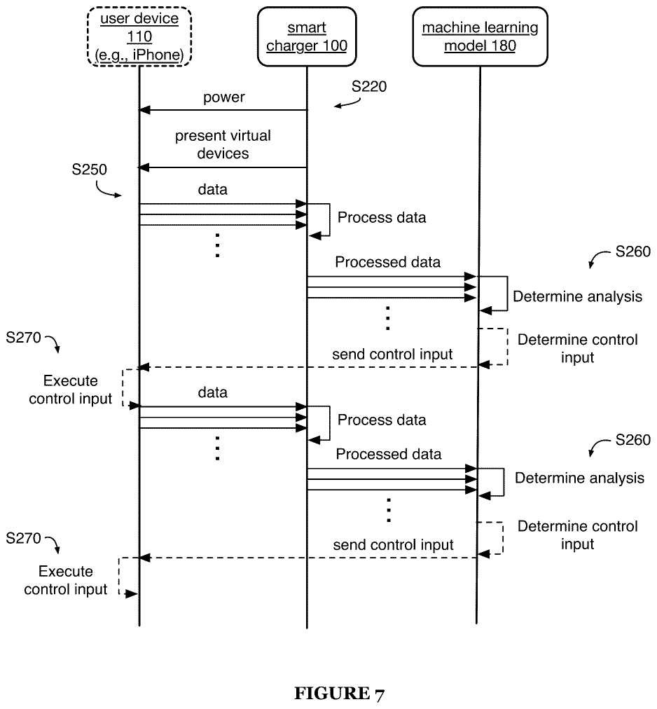

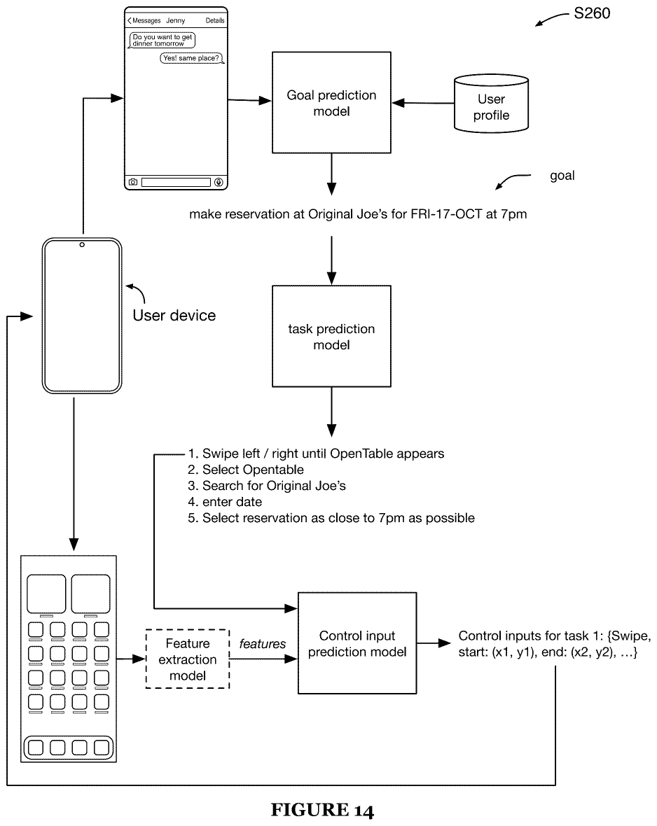

In an example, the method can include iteratively receiving data (e.g., a frame, a screenshot, etc.) from the user device (e.g., requesting data from the user device), extracting features of interest (e.g., objects, locations of UI elements) within the received data (e.g., using an ML model), determining an action (e.g., which UI element to select, the type of gesture that should be applied to the UI element, etc.) based on the extracted features of interest and a predetermined goal determined from historical user data (e.g., determined by a ML model, etc.), and executing the action on the user device, wherein a new frame is requested from the user device after the action has been executed. In variants, the method can enable the smart charger to automatically execute a set of tasks (e.g., goals, sub-goals) on the user device. Examples are shown in FIG. 7, FIG. 8, and FIG. 14.

The method can automatically generate one or more analyses for the user. The analyses that can be implemented can include generating a user profile for the user, generating an analysis on behalf of the user (e.g., a synthetic voice response, a synthetic text response, etc.), performing a task for the user, and/or any other analysis. Examples of the tasks that can be performed can include responding to a communication (e.g., email, text message, direct message, etc.), making a reservation, scheduling a meeting, posting a message, and/or any other task.

In an illustrative example (e.g., example shown in FIG. 8), the method captures and stores all text messages from a particular messaging thread on an iPhone. The method can include connecting to the iPhone (e.g., using the USB-C device connector), optionally registering with the iPhone as a display and input accessory, receiving display data (e.g., continuously, periodically, etc.), optionally converting the received display data (e.g., from a DisplayPort format to a MIPI-DSI and/or FPD-Link format), determining information based on the converted data (e.g., detecting one or more UI elements associated with navigating to a messaging thread, optionally storing message content from the messaging thread, etc.), determining control inputs based on the data (e.g., predicting input gestures to navigate to the messaging thread, scroll through the messaging thread, capture screenshots of the messaging thread, etc.), and providing the control inputs (e.g., executing the input gestures on the user device as an emulated input accessory, via the USB-C device connector, etc.).

In variants, the method can be iteratively performed.

The method is preferably performed by the system as described above, more preferably by the smart charger, but can additionally or alternatively be performed by any other set of components.

Connecting to a user device S210 functions to establish a power and/or data connection with the user device. S210 preferably includes connecting the smart charger to the user device, more preferably connecting the user device connector of the smart charger to a power/data port of the user device, but can additionally or alternatively include connecting the user device to another device. The connection is preferably a physical connection (e.g., using the user device connector), but can additionally or alternatively be a wireless connection (e.g., inductive connection, Bluetooth classic, Bluetooth Low Energy, Wi-Fi, near field communication, etc.), and/or otherwise connecting the smart charger to the user device.

The connection can be a power connection (e.g., transmitting power to the user device, receiving power from the user device, etc.), a data and power connection (e.g., a USB-C connection head), and/or any other connection.

However, connecting to a user device S210 may be otherwise performed.

Providing electrical power to the user device S220 functions to charge and/or power the user device. The electrical power can be provided via the user device connector, the data connection, an inductive contact, or any other power connection. Alternatively, the user device can be connected to the system without providing power (e.g., for all or a portion of the connection duration). the smart charger can power the user device: at all times while connected; only when the system is also connected to a power source (e.g., via the power connector, etc.); and/or at any other time.

In variants, device charging can be turned on and off while connected to the user device. In variants, the processing unit, the power management circuit, mode switch, and/or other component can control the charging mode (e.g., charging on, off). In an example, the processing unit can send a signal to the power management circuit to change the charging mode.

S220 can provide power from an external power source (e.g., via the power connector), an internal power store (e.g., battery), and/or any other suitable source.

User device charging can occur: after connecting to a user device, after registering with the user device as an accessory, after identifying the user device, after authenticating the user device, after authenticating the user, and/or at any other time.

However, providing electrical power to the user device S220 may be otherwise performed.

The method can optionally include authenticating the user S230, which functions to identify the user, verify that the smart charger has permissions to access the user device, and/or any other suitable authentication processes. S230 can be used to select the correct user profile, user device access permissions, and/or other data associated with the user. This can be particularly useful when the smart charger is used for multiple user devices and/or multiple users. S230 can be performed by the smart charger, by the remote computing system, by the user device, and/or by any other system.

In a first example, the smart charger can ensure that the same user profile and permissions are used across all devices owned by a specific user. In a second example, the smart charger can ensure that another user's profile and/or permissions are not used when predicting analyses for the user (e.g., with the connected user device). In a third example, the user device can ensure that user data is not being provided to unauthorized smart chargers.

Authenticating the user S230 can include identifying the user, determining user device access permissions associated with the user, and/or any other authentication process.

Identifying the user can include optionally storing stored credentials, receiving an input credential, comparing the stored credentials and the input credential, and/or identifying the user associated with a stored credential that matches the input credential.

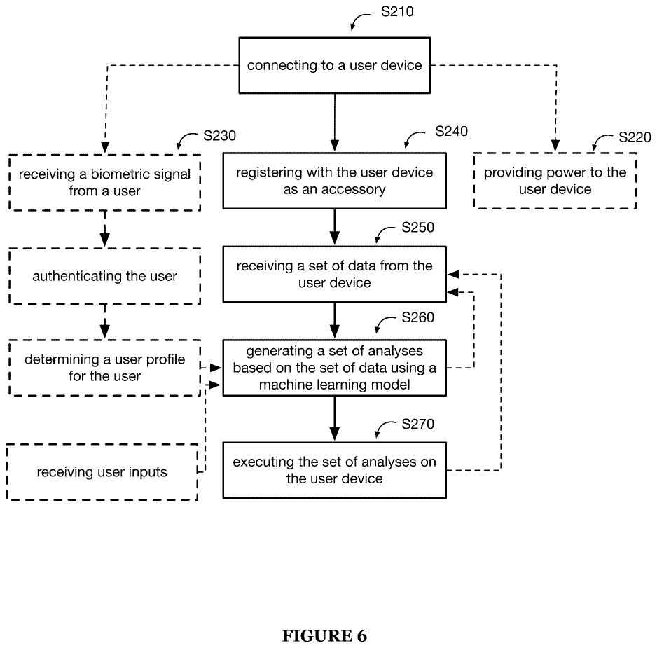

The stored credentials can store multiple stored keys. The stored keys can be stored on the smart charger, the user device, the remote computing system, and/or any other system. The stored credentials can be a default credential (e.g., approval receipt), a user-specified credential (e.g., a fingerprint, a PIN, an unlock pattern, etc.), and/or be otherwise determined. The input credential is preferably received at the smart charger, but can alternatively be received at the user device and/or at any other credential input. Examples of receiving the input credential at the user device can include receiving the credential on an application on the user device, unlocking the user device with a password or biometric, manually acknowledging the connection on the user device, and/or any other method of receiving the input credential at the user device. The input credential can be received using a biometric sensor, a user input (e.g., touchscreen, etc.), and/or received using any other input method. An example is shown in FIG. 6.

The credentials can include a password, a biometric (e.g., fingerprint, retina, face, etc.), a radio frequency, a rolling code, a user device identifier, a certificate issued by the smart charger, and/or any other credential type.

The user device access permissions associated with the user can be retrieved, received from the user, and/or otherwise determined.

The user device access permissions can include whether the smart charger can access the user device data, what data the smart charger can access (e.g., display data, audio data, application data, etc.), and/or any other access permission. The user device access permissions can be stored onboard the smart charger (e.g., by the processing unit), by a remote computing system, by the user device, and/or any other storage location.

S230 can be repeated each time a user connects a user device to the smart charger, can be repeated after a time interval, can be repeated after the user device sleeps, and/or at any other time. After or in response to authenticating the user, the method can register the smart charger with the user device as an accessory, receive data from the user device at the smart charger, send data to the user device (e.g., from the smart charger, from the remote computing system, etc.), predict a set of analyses based on the data using a machine learning model, execute a set of tasks on the user device, and/or perform other processes.

In a first variant, the smart charger receives a certificate (e.g., issued by the smart charger) from the user device, wherein the smart charger identifies the user profile and the user device access permissions associated with the certificate.

In a second variant, the user device provides a device identifier to the smart charger, wherein the smart charger identifies the user profile and user device access permissions associated with the device identifier.

In a third variant, the smart charger receives a user biometric (e.g., at an onboard biometric sensor), wherein the smart charger identifies the user profile and the user device access permissions associated with the user biometric.

However, authenticating the user S230 may be otherwise performed.

Registering with the user device as an accessory S240 functions to enable input and/or output capabilities with the user device. In variants, the access and control inputs from applications can be tightly controlled by the user device's operating system (e.g., permit limited access to a predetermined set of applications on the user device).

In a first example, iOS may only permit screensharing to Zoom and native applications. In a second example, the device may not be able to advertise as multiple conflicting device types simultaneously.

The smart charger is preferably registered with the user device as an input and/or output accessory, but alternatively other devices can be registered with the user device as an accessory.

Examples of accessories that the smart charger can register as can include displays, speakers, microphones, human interface devices (e.g., input devices, such as keyboards, mice, styluses, touchpads, etc.), and/or any other emulated accessory. In a specific example, the smart charger can register as a display and as a set of input devices (e.g., keyboard, mouse, etc.). In this specific example, the smart charger can omit the physical version of the emulated accessories (e.g., exclude a display, exclude a keyboard, exclude a mouse, etc.), or include the physical version of the emulated accessory.

The emulated accessory can: receive data from the user device, execute inputs to the user device (e.g., keystrokes, clicks, swipes, etc.), and/or perform other functions.

S240 can include presenting the smart charger as one or more virtual devices to the user device, and/or otherwise registering the smart charger as an accessory. In a first example of registering with the user device as an accessory, the smart charger can advertise as a USB hub with HDMI output and USB keyboard. In a second example of registering with the user device as an accessory, the smart charger can advertise as a computer requesting phone backup. In a third example of registering with the user device as an accessory, the smart charger can simultaneously appear as display, mouse, keyboard, speaker, and microphone.

The smart charger can concurrently emulate one or more accessories, dynamically switch between different virtual devices (e.g., emulated accessories) presented to the user device (e.g., based on the task predicted by the analysis, based on a schedule, etc.), and/or emulate any other set of accessories at any other time. S240 can be performed using the user device connector or via a separate connection (e.g., wireless connection).

S240 can be performed after authenticating the user, after acknowledging the connection to the user device, after connecting to the user device, in response to connecting to a user device, in response to receipt of a user input, in response to receipt of an input from an application on the user device, in response to authenticating the user device, in response to identifying the user device, in response to identifying the user, in response to authorization from the user, and/or any with other timing or trigger condition.

The smart charger can register as an accessory using an accessory authentication chip, using a set of HID credentials, and/or otherwise registering with the user device as an accessory.

In an example, the smart charger can advertise itself as an accessory (e.g., over Bluetooth, USB-C, the user device connector, etc.); negotiate the communication protocol with the user device (e.g., the user device determines the set of protocols supported by the smart charger and selects a protocol from the set); use the accessory authentication chip to authenticate itself with the user device (e.g., exchange cryptographic challenges, provide the HID descriptor, etc.), wherein the user device can enumerate the accessory as an authenticated accessory (e.g., as an external display, as a keyboard, as a mouse, etc.); establish a data exchange session with the user device after the user device authenticates the smart charger (e.g., EAsession, HID connection, etc.); optionally receive user device capabilities from the user device (e.g., screen size, resolution, supported input events, orientation, multitouch capabilities, etc.); optionally send smart charger capabilities to the user device (e.g., supported display modes, input modes, etc.); and send and/or receive data with the user device through the established session.

The user device can remember the smart charger (e.g., reuse the trusted session without re-registration, autoconnect with the smart charger in future sessions, allow applications associated with the smart charger to launch automatically, etc.), forget the smart charger, and/or otherwise persist the authentication. However, the accessory authentication chip can be otherwise used to authenticate the smart charger with the user device(s).

However, registering with the user device as an accessory S240 may be otherwise performed.

Receiving a set of data from the user device S250 functions to receive user data from the user device. The data received from the user device in S250 preferably includes media (e.g., graphics, audio, visual data), but can additionally or alternatively include phone backups, lists (e.g., of applications, capabilities, etc.), device state data (e.g., battery status, call status, etc.), credentials (e.g., WiFi credentials, passphrases, username/password, cellular credentials, SIM credentials, authentication keys, etc.), and/or any other data. The data is preferably representative of the current user device state, but can alternatively be representative of past user device states and/or any other user device state.

In an example, the data can be representative of part or all of the display state of the user device (e.g., include screenshots), audio state of the user device (e.g., include audio streams), application state (e.g., whether the application is logged in, etc.), and/or any other state of the user device.

The data can be requested by the smart charger (e.g., periodically, continuously, upon occurrence of a predetermined event, etc.), pushed by the user device, provided by the user (e.g., entered by the user, etc.), and/or otherwise obtained.

The data can include media from the user device, user instructions, device state data, user network data, user device capabilities, and/or any other data.

The media from the user device can include screenshots, screen recordings (e.g., video), subsets of the screen display, audio received by the user device (e.g., phone call, microphone), playback media on the user device, and/or any other media from the user device.

The user instructions can include user audio input, user inputs to an application on the user device, user interface inputs, and/or any other user instructions. The user instructions can be received from the user device, the external interface set onboard the smart charger, an application on the user device, stored data (e.g., stored in the processor, the remote computing system, etc.), an auxiliary device, and/or any other source.

The device state data can include battery level, location, call status, network connectivity status, and/or any other device state data. The user network data can include network type, network credentials, devices discovered on LAN, devices discovered on the network, and/or any other user network data. The network credentials can include SSID, BSSID, Cell ID, Wi-Fi passphrase, SIM and/or eSIM credentials, and/or VPN credentials. The user device capabilities can include screen size, resolution, supported input events, orientation, multitouch capabilities, downloaded applications, logged-in applications, application capabilities (e.g., call, register, reserve, search, etc.), and/or any other user device capabilities.

Capturing visual data can include capturing snapshots, video streams, and/or other visual data. The visual data can be captured at regular intervals (e.g., every 1 s, 2 s, 5 s, 10 s, etc.), captured in response to providing control inputs to the user device (e.g., capturing one or more snapshots during and/or after providing the control inputs, such as a threshold amount of time after providing the control inputs), captured in response to changes in display state (e.g., exceeding a threshold degree of change from the previous snapshot), and/or with any other suitable timing.

Video streams can be captured at any suitable frame rate (e.g., at the frame rate received from the data stream, at a lower frame rate, such as wherein only one out of a predetermined number of consecutive frames are saved, etc.). However, any other suitable visual data can be captured from the display data stream. In an example, capturing visual data can include capturing the content of messages in a thread, capturing the content of all message threads within an app, capturing the content of all communications with a particular contact across all apps, and/or any other content. S250 is preferably performed after or in response to registering with the user device as an accessory, but can alternatively be performed after or in response to connection with the user device, after authenticating the user, and/or at any other time.

S250 is preferably performed while connected to the user device, but can additionally or alternatively be performed while the mode switch is in a predetermined state (e.g., cognitive mode). S250 is preferably performed continuously while connected to the user device (e.g., throughout the duration of the connection, throughout performance of the method, etc.), but can alternatively be performed for a subset of the connection time and/or with any other suitable timing. In an example, data can be received periodically (e.g., 0.5 milliseconds to 10 second periods, 1 millisecond, 5 milliseconds, 100 milliseconds, 500 milliseconds, 1 second, 2 seconds, 5 seconds, etc.).

The data is preferably received via the one or more connections established by connecting to the user device (e.g., via the user device connector, wireless communications, etc.), but can additionally or alternatively be received via any other suitable connections.

In a first variant, the data can be received through the user device connector.

In a second variant, the data can be received through a wireless connection (e.g., Bluetooth accessory connection).

In a third variant, the data can be received from an application, wherein the application samples the device state and/or other data and sends the data to the smart charger. The data is preferably processed by the smart charger after receipt, but can additionally or alternatively be used in a raw format.

Examples of processing the data can include: converting the data to a different data format, changing the signal bandwidth, compressing the data, encrypting the data, removing personally identifiable information from the data (e.g., replacing the PII with a nonce, removing it entirely, etc.), converting from a first modality to a second modality (e.g., from audio to text), extracting objects or other features of interest within the data (e.g., locations of buttons or menus, locations of application icons, text, audio features corresponding to words or noises of interest, etc.), embedding features of interest into a latent space (e.g., embedding text into a latent space, etc.), and/or any other processing method.

The data can be converted to a different data format at the media conversion chip in the control block. Additionally or alternatively, the data can be converted into a different format at the user device. The data can alternatively be retained in the format it was received (e.g., raw format). In an example, he data can be received from the user device in a first format and converted into a second format interpretable by the processing unit.

The received data (e.g., raw data) can be immediately removed after processing, stored for a predetermined period of time, and/or otherwise managed.

In examples, processing the data upon receipt can increase user privacy and/or security, reduce the amount of storage required onboard the smart charger, and/or confer other benefits.

The received data can be sent to the processing unit, sent to a remote network by the processing unit, stored by the processing unit, and/or otherwise managed.

However, receiving a set of data from the user device S250 may be otherwise performed.

Generating an analysis based on the set of data S260 functions to construct a structured representation of user data, provide insights based on the user data, and/or generate a workflow based on the structured representation. S260 can be performed in response (e.g., immediately) to receiving data, in response to a trigger, in response to a user input, periodically, or at any other time.

The analyses can be predicted by a set of ML models (e.g., using a single ML model, an agentic workflow, etc.), determined using a set of rules or heuristics, computed using a set of equations, and/or otherwise generated.

The analyses can be generated at the smart charger (e.g., the processing unit), the user device, the remote computing system, and/or by any other compute. The analyses can include a user profile (e.g., preferences, history of events, etc.), a set of insights based on the user profile, a set of goals, a set of tasks (e.g., to accomplish a goal,). a set of actions (e.g., low-level user device interactions to accomplish a task), and/or other analyses.

In variants, generating an analysis based on the set of data S260 can include: extracting information from the set of data; storing the data; and analyzing the extracted information; and/or other processes.

Extracting information from the set of data can include: extracting features of interest from the data; determining a user profile from the data; and/or extracting other information from the data.

Extracting features of interest from the data functions to interpret features from the data and/or convert elements of the data into features processable by the processing unit. The features of interest can include object parameters (e.g., identities, locations on the user device, etc.), text, audio features (e.g., words, noises, etc.), application lists, application navigation maps, a set of latent embeddings (e.g., in a semantic space, signal space, etc.), and/or any other features. Examples of the object parameters can include application icons and interaction icons (e.g., buttons, sliders, text boxes, upload fields, etc.). The features of interest can be determined based on: the data, a representation of the data (e.g., embedding), a task, information gathered to achieve a goal and/or task, a set of rules, the operation mode, a user input, and/or any other basis.

The features of interest can be determined using symbol recognition, computer vision algorithms, optical character recognition (e.g., to determine UI element labels, to extract text information displayed by the user device, etc.), image recognition techniques (e.g., to detect and/or interpret graphical UI element functions, graphical information displayed by the user device, etc.), neural networks, and/or any other method. Examples of symbol recognition methods that can be used include identifying user interface elements, emojis, and/or any other symbol recognition method. Examples of computer vision algorithms that can be used can include layout analysis, feature matching, template matching, edge detection (e.g., to locate UI elements), and/or any other computer vision algorithm. Examples of neural networks that can be used can include graphical neural networks, convolutional neural networks, transformers, and/or any other neural network. In a first example, the neural network can detect predetermined objects in the data (e.g., predict labeled bounding boxes around the identified objects). In a second example, the neural network can output an embedding of the data. In a third example, the neural network can predict a description of the data.

The features of interest can be determined after receiving media, after receiving a task, after a change in the display at the user device, and/or after any other condition. The features of interest can be predicted by a machine learning model, heuristically determined, and/or otherwise extracted. The features of interest can be determined at the control block, an application on the user device, a remote computing system, and/or any other location.

However, extracting features of interest from the data may be otherwise performed.

Determining a user profile from the data functions to extract a structured representation of the user. The user profile can include user preferences (e.g., preferred applications, preferred restaurants, etc.), authorization keys (e.g., passwords, biometrics, etc.), network credentials, location data (e.g., home location, work location, etc.), voice audio, user device identities, media from the user device, text messages, emails, calendar events from the user device, locally stored user device data, user behavior patterns and preferences, a user schedule, user to-do list, user sentiments, interaction history, and/or any other user profile data. The user preferences can be learned from historical data, manually specified by the user, and/or otherwise determined. The user profile can be a knowledge graph, a set of summaries, a set of latent embeddings (e.g., for one or more profile fields, etc.), a trained model (e.g., a set of model weights, biases, parameters, etc.), a set of raw data, a set of clusters, a set of rules, a behavioral sequence, and/or have any other representation structure.

The user profile is preferably specific to a user (e.g., a user identifier, a set of credentials, a set of user devices, etc.), but can additionally or alternatively be shared between users. The user profile can be determined based on the newly-received data, a history of data (e.g., raw data), the prior user profile and the newly-received data (e.g., the new data is used to update the user profile, etc.), and/or any other basis.

The user profile can be determined using: the set of ML models (e.g., an LLM, a transformer, etc.), a predetermined program, and/or any other suitable method. The user profile can be determined every time new data is received from the user device, periodically (e.g., to summarize recent data received from the user device), when a predetermined type of data is received (e.g., messages, incoming or outbound communications, etc.), and/or at any other time.

In a first variant, determining the user profile can include embedding the new data into a set of latent vectors (e.g., RAG vectors, LLM embeddings, etc.) and storing the set of latent vectors in association with a user identifier.

In a second variant, determining the user profile can include embedding the new data and prior latent vectors for the user into a new set of latent vectors and storing the new set of latent vectors in association with a user identifier.

In a third variant, determining the user profile can include prompting an LLM to summarize the new data into a summary (e.g., guided by a predetermined prompt), and storing the summary in association with the user identifier.

In examples, determining the user profile can include sending data to a remote computing system, receiving processed information from the remote computing system, discarding the set of inputs, encrypting the processed information, storing model weights for a user, maximizing a reward associated when a model predicts a user input, labelling the data, categorizing the data, associated data with a cluster, extracting features from the data, transforming the data, anonymizing the data, encoding the data into a latent space, constructing a data structure, populating a data structure, modelling user behavior over time, and/or using any other process or activity.

The user profile can be determined by the processing unit, by the user device, by an application on the user device, by the remote system (e.g., by a set of ML models on the remote computing system), and/or any other suitable system. The user profile can be stored: by the processing unit (e.g., in a secure enclave, in a user profile repository, etc.), by another component in the smart charger, by the user device, by the remote computing system, by an application on the user device, and/or any other suitable storage location.

However, determining a user profile from the data may be otherwise performed.

However, extracting information from the set of data may be otherwise performed.

Generating an analysis can include storing the data. The data can be stored at a remote memory storage, in the control block, on the user device, and/or any other storage location. The data can include a user profile, a key or credential to retrieve the user profile, the user identifier, raw user data, and/or any other data. The data can be stored in a raw format, in a processed format (e.g., as a set of features, embeddings, etc.), and/or otherwise stored. Storing the data can, in examples, include storing the text content of a text display area (e.g., from a messaging session) displayed by the user device, storing UI element locations, labels, and/or functions, and/or storing any other suitable information.

However, storing the data may be otherwise performed.

Generating an analysis can include analyzing the extracted information. In variants, analyzing the extracted information can include: determining a set of goals; determining a set of tasks; determining a set of control inputs, and/or otherwise analyzing the extracted information.

Determining a set of goals functions to determine a set of high level goals for the smart charger. Examples of goals that can be determined can include organizing an event for the user, responding to a query, organizing data on the user device, retrieving information, assisting a user request, and/or other goals.

In a first example, a goal can include organizing information. In an illustrative example, a user wants to clear storage on the user device and the goal provided to the ML model is to reduce the amount of data stored on the phone. In a second illustrative example, the model determines that the user is experiencing a stressful event and determines a goal of organizing stress-managing resources for the user.

In a second example, a goal can include organizing an event based on context extracted from the data. In a specific example, determining a set of goals includes capturing the content of a text conversation and determining a goal of coordinating a plan with a friend. In another specific example, determining a set of goals includes detecting an upcoming birthday and determining a goal of planning a celebration.

In a third example, a goal can include executing a task on the user device. In a specific example, the model receives information about a calendar event and sets the goal of reminding the user of the event.

The set of goals can be determined based on data from the user device, the user profile, user inputs, and/or any other information. The data from the user device can include calendar events, inquiries received by the user on the user device, user device states, and/or any other data from the user device. The user profile can include user behavioral patterns, user preferences, frequent actions, sleep patterns, frequent contacts, frequently opened apps, and/or any other user profile information. The user inputs can include user queries, user settings, and/or any other user inputs.

The set of goals can be determined using a model (e.g., machine learning model, DNN, transformer, LLM, diffusion model, etc.), a set of rules, and/or any other mechanism. In a first example, the set of rules can include a predetermined set of goals that are associated with a user input. In a second example, the set of rules can include a predetermined set of goals associated with a time of day.

The goals can be determined by: predicting a set of goals based on the data received from the user device and optionally the user profile (e.g., prompting an LLM to output a set of goals based on the data, classifying the data into a set of predetermined goals using a trained classifier, etc.), looking up a set of goals (e.g., based on features extracted from the data), and/or otherwise determined.

However, determining a set of goals may be otherwise performed.

Determining a set of tasks functions to take steps to achieve the set of goals. A task can include a decomposition of a goal, a set of lower-level goals determined from the goal, a set of targets achievable by a predetermined number of actions (e.g., a single action, etc.), and/or be otherwise defined.

Examples of the tasks that can be used can include: determining which data to obtain from the user device, requesting additional data from the user device, acquiring auxiliary data, determining which data to use from a user profile, navigating to a predetermined target on the user device (e.g., target application, target screen location, target application menu item, etc.), interacting with a third party system (e.g., composing an API request, sending the API request, etc.), determining auxiliary steps, executing a task on the user device, and/or any other task.

In a specific example of acquiring auxiliary data, after determining the goal of reducing stress for the user, the model determines a set of tasks including: searching for stress reducing strategies, organizing information about stress reducing strategies, and displaying them to the user.

In a specific example of determining which data to use from a user profile, after determining a goal of making a restaurant reservation, the model retrieves data from the user profile associated with food preferences, dietary restrictions, visit history, restaurant preferences, etc.

In a specific example of determining auxiliary steps, after determining a goal of reducing stored data on the user device, the model determines a set of tasks, including: ranking categories of data by consumed storage, reducing stored photos, detecting duplicate photos, presenting options to the user, and/or otherwise reducing stored data on the user device

In a specific example of executing a task on the user device, after determining the goal of reminding a user about an event, the model determines tasks including: creating a calendar event, setting an alarm on the user device, and communicating the event to invited guests.

The set of tasks can be determined based on: the set of goals, user input, a predetermined schedule, the user profile, auxiliary information (e.g., weather, traffic, etc.), the user device capabilities, application capabilities, and/or any other suitable information.

The set of tasks can be determined using a machine learning model, a predetermined set of rules, a decision tree, and/or any other method. In an example of the machine learning model, an LLM that can be prompted to determine a set of tasks, given a goal, the user profile, the data (e.g., screenshot), and/or other information as an input.

However, determining a set of tasks may be otherwise performed.

Determining a set of control inputs functions to determine inputs that can be used to control the user device. The set of control inputs are preferably automatically generated, but can additionally or alternatively be received from the user or otherwise determined.

The set of control inputs can include input gestures (e.g., keystrokes, swipes, patterns, etc.) and user device commands (e.g., requests to a library, an API, etc.; requests for device backups; etc.). The input gestures can include a set of user device coordinates (e.g., a start coordinate, an end coordinate, a set of intermediate coordinates, etc.), a gesture type (e.g., select, swipe, etc.), and/or any other input gesture component. The input gestures can be predicted (e.g., using a ML model), determined heuristically, determined probabilistically, determined using a lookup table, and/or otherwise determined.

In a first example, an ML model can predict a stop coordinate location on the user device screen (e.g., based on the data, such as a screenshot) and an input gesture to execute at the stop coordinate location. In a second example, an ML model can predict a start and stop coordinate location on the user device screen (e.g., based on the data) and an input gesture to take between the start and stop coordinate location.

In variants, determining the input gestures can include perturbing the input gesture parameters (e.g., trajectory, precision, acceleration, etc.), which can generate naturalized input gestures. The perturbations can be randomly determined, determined by adding a predetermined amount of noise, computed, be predicted by a model trained on human input gesture parameters, and/or otherwise determined.

In examples, the control inputs can include one or more mouse clicks (e.g., specifying click locations and/or timing), swipes (e.g., specifying swipe trajectories, applied pressures, touch region shapes and/or areas, etc.), keyboard entry sequences (e.g., specifying particular keys and/or key combinations and/or the timing thereof), and/or other control inputs.

The set of control inputs are preferably determined based on the task, the data, and the user device capabilities (e.g., without using user preferences), but can additionally or alternatively be determined based on the user preferences and/or any other information.

The control inputs can be executed to achieve a goal or task, or otherwise used.

In a specific example of determining a set of control inputs, the goal can be making a reservation, and the set of tasks can include navigating to a restaurant reservation application, opening the application, navigating the user interface to access a list of restaurants, selecting a restaurant, selecting a time, confirming the reservation, switching to a messaging app, selecting a friend associated with the reservation, inputting a predetermined set of text, and sending a message. The set of control actions for navigating to a restaurant reservation application can include: swiping up from the a first screen location associated with the application menu, sampling a screenshot of the display, determining whether a restaurant reservation application appears in the screenshot (e.g., using an object detector, classifier, embedding model, etc.), repeating the process until a restaurant reservation application appears in the screenshot, and selecting a screen location within a bounding box for the restaurant reservation application's icon. The remaining tasks can have similar sets of control actions that collectively achieve the respective task.

Control inputs can be determined based on a goal, a task, and/or any other suitable information. Control inputs can be determined once or iteratively determined. In a specific example, the model can determine a goal, determine control inputs to obtain more information, use the obtained information to determine a task, determine additional control inputs to determine how to achieve the task, and/or otherwise iteratively determine control inputs.

Control inputs can be determined using an ML model (e.g., predicted using an LLM, etc.), composited using a predetermined template (e.g., wherein the template variable values can be predicted by an LLM, extracted from the data, etc.), and/or any other suitable method. In an example, navigating to an application can be associated with a predetermined series of control actions, wherein the start and/or stop target values (e.g., target applications, target screen locations, swipe start and stop locations, etc.) can be dynamically determined based on the task and the data received from the user device.

The control inputs can be determined based on current states, stored data, a set of goals, a set of tasks, and/or any other basis. The current states can include user device media, user device states, time of day, and/or any other current states. The stored data (e.g., stored on the user device, an app on the user device, the smart charger, a remote memory, etc.) can include media, data from the user device, textual data, interactions, control inputs, user profile, user interface elements, and/or any other stored data.

However, determining a set of control inputs; may be otherwise performed.

However, analyzing the extracted information may be otherwise performed.

However, generating an analysis based on the set of data S260 may be otherwise performed.

The method can optionally include executing the set of analyses S270, which functions to implement any tasks predicted by the analyses. In an example, can include controlling the user device (e.g., based on the tasks, using the actions, using the control inputs, etc.), interacting with a third party system (e.g., a service API, a service endpoint, etc.), and/or performing other processes.

Examples of controlling the user device (e.g., based on the tasks, using the actions, using the control inputs, etc.) can include playing media, sending data to a remote computing system, another user, and/or any other otherwise controlling the user device.

S270 is preferably performed by the smart charger (e.g., processing unit), but can additionally or alternatively be performed by the remote computing system, the user device, an application (e.g., running on the user device), and/or any other system. S270 is preferably performed based on the set of control inputs, but can additionally or alternatively be performed based on a set of calls, instructions, and/or any other set of actions. S270 is preferably performed in response (e.g., immediately, asynchronously, etc.) to determining the control inputs, but can alternatively be performed at any other time.

In a first variant, executing the set of analyses S270 can include emulating one or more virtual devices and providing the determined control inputs to the user device. The control inputs are preferably provided at the data connector, but can additionally or alternatively be provided via wireless communications and/or in any other suitable manner. In a first example of the first variant, the method can include generating USB communications to emulate the one or more virtual USB devices. In a second example of the first variant, the method can include presenting as a keyboard and providing keystroke data to the user device. In a third example of the first variant, the method can include simulating a human swipe interaction by simulating the acceleration profiles of the swipe. The swipe acceleration profile can be stored on the processing unit, and the virtual accessory can execute the swipe acceleration profile. In a fourth example of the first variant, the method can include simulating a user. In a first embodiment of the fourth example, simulating a user can include generating a human-like acceleration profile with easing curves to simulate a swipe. In a second embodiment of the fourth example, simulating a user can include mimicking human interaction timing and position for clicking.

In a second variant, executing the set of analyses S270 can include determining an endpoint (e.g., API endpoint, etc.), generating variable values for the endpoint, constructing a request based on the endpoint schema and variable values, and sending the request to the endpoint. In an example of the second variant, the system can include constructing an OpenTable reservation API request and sending the API request to an OpenTable endpoint.

In a third variant, executing the set of analyses S270 can include controlling the user device using zero-width character steganography, which can include information hidden from human users but visible to another computer. The messages sent on behalf of a user to the user device can include zero-width Unicode characters containing additional context about an interaction. In an example, the message can appear to humans as “dinner Thursday?” but contain various location and scheduling logistics. The receiving agent can decipher the hidden context and confirm a plan with fewer interactions than humans.

In a second example, the characters can include zero-width space (U+200B), zero-width non-joiner (U+200C), zero-width joiner (U+200D), and/or any other characters.

S270 can optionally include updating the set of tasks based on new display data. In examples, this can be particularly useful when the set of tasks includes a task to obtain new data from the user device, wherein the new data can be used to: generate a new set of tasks, update an existing task in the set (e.g., a subsequent task), update the set of actions for a task (e.g., update the target coordinates), and/or otherwise used.

Updating the set of tasks based on new display data can include an iterative process. In a specific example, the predicted task is making a restaurant reservation. This can include iteratively receiving screen display graphics from the user device, identifying target UI elements from the screen display graphics, controlling the user device with a click from a virtual stylus at the target UI elements, receiving a new set of screen display graphics, identifying new UI elements from the new set of screen display graphics, controlling the user device with keystrokes from a virtual keyboard based on the new UI elements, optionally prompting the user to provide an instruction (e.g., selection, additional input, etc.), optionally receiving an instruction from the user, optionally generating new actions based on the instruction and optionally an updated set of screen display graphics, and controlling the user device using the new actions.

However, executing the set of analyses S270 may be otherwise performed.

The method can optionally include switching between operation modes S280, which functions to enable the user to control the smart charger's operation mode.

The switching between operation modes S280 can be performed in response to a user instruction, in response to a user interaction, after a predetermined time period, after a time period with no interactions, in response to the conclusion of a task, in response to detection of a predetermined user pattern, when the mode switch is set to a predetermined position, and/or upon occurrence of any other condition.

In variants, S280 can include cross-device handoffs.

In a variant, cross-device handoffs can include the charger communicating with other user devices (e.g., wirelessly, wired, through a local network, Bluetooth, etc.).

In a variant, cross-device handoffs can include when a user uses a second user device, the second user device can act as an extension of the first user device. In a first example of the variant, when the first user device is plugged into the charger, and a user goes to a meeting on a second user device, second user device can send information to the charger about the meeting. In a second example of the variant, a home speaker can communicate with the charger (e.g., act as a microphone, alert user about phone activity). The cross-device handoff can be controlled by the processing unit, by the user device, by an application on the user device, by the mode switch, and/or any other suitable controller. In a first example, after receiving a direction to switch between the modes of operation, the processing unit can send a signal to the power management circuit and/or the power delivery mechanism to change the status of power provided to a component.

In a second example, after receiving a direction to switch between modes of operation, the processing unit can initiate a connection to a remote network, send data to a remote network, send data to a locally stored and executed ML model, and/or send a signal to provide power to an input/output device.

S280 can optionally include providing switch feedback, which can function to inform the user that the operation mode has changed and/or which operation mode the smart charger is operating in. The switch feedback can include haptic feedback, a light indicator, a position indicator on the mode switch, a displayed text description or visual icon, and/or any other feedback. In an example, upon switching between modes of operation, a motor can provide haptic feedback from the control block. In an example, upon switching between modes of operation, a motor in the control block connected to the user device connector can move a cable on the user device connector (e.g., a twist, change in cable tension, etc.).

However, switching between operation modes S280 may be otherwise performed.

### Specific Examples

Specific example 1: A method comprising, with a smart charger: establishing a connection to a user device, the connection comprising a power and data connection; powering the user device through the connection; registering with the user device as an accessory through the connection; receiving a set of data comprising media from the user device as the accessory, through the connection; determining a set of tasks based on the set of data, comprising predicting the set of tasks using a machine learning model; and executing the set of tasks on the user device through the connection. In a specific example, the smart charger comprises a wall outlet connector and a user device connector.

Specific example 2: The method of specific example 1, wherein: the set of tasks comprises an input gesture, and executing the set of tasks comprises executing the input gesture on the user device.

Specific example 3: The method of specific example 1, further comprising authenticating a user before receiving the set of data:

Specific example 4: The method of specific example 3, wherein authenticating the user comprises receiving a biometric signal and comparing the received biometric signal to a stored biometric signal associated with the user.

Specific example 5: The method of specific example 1, further comprising iteratively receiving a set of data and determining the set of tasks.

Specific example 6: The method of specific example 1, wherein the smart charger comprises a wall outlet connector and a user device connector.

Specific example 7: The method of specific example 1, wherein the set of data further comprises a set of user instructions received from a user, wherein the set of tasks is predicted based on the set of user instructions

Specific example 8: The method of specific example 1, further comprising: receiving a mode switch instruction from a user; and switching to a charging mode, wherein the smart charger does not receive data from the user device when providing electrical power to the user device.

Specific example 9: The method of specific example 1, further comprising augmenting a user profile based on the set of data and predicting the set of tasks based on the user profile:

Specific example 10: The method of specific example 1, wherein the media comprises screenshots from the user device:

Specific example 11: The method in specific example 1, wherein the media audio from phone calls on the user device.

Specific example 12: A method comprising, at a smart charger: connecting to a user device; and while powering the user device: receiving a set of media from the user device through the connection; determining a set of tasks based on the set of media, using a task prediction model; determining a set of control inputs for each task of the set of tasks using a control input prediction model, wherein the control inputs comprise low-level atomic user device inputs; and controlling the user device to execute each set of control inputs through the connection.

Specific example 13: The method of specific example 12, further comprising registering with the user device as an input/output (I/O) accessory using an accessory authentication chip onboard the smart charger, before receiving the set of media.

Specific example 14: The method of specific example 12, further comprising iteratively: receiving media from the user device, determining updated sets of control inputs, and controlling the user device based on the updated sets of control inputs until a task from the set of tasks is complete.

Specific example 15: The method of specific example 12, further comprising: receiving a mode switch instruction at the smart charger; and switching to a power-only mode in response to receiving the mode switch instruction:

Specific example 16: The method of specific example 12, wherein the task prediction model acts as the control input prediction model:

Specific example 17: The method of specific example 12, wherein the task prediction model is executed by a remote computing system, remote from the smart charger and user device, wherein the task prediction model predicts the set of tasks based on a representation of the set of media that is sent to the machine learning model by the smart charger.

Specific example 18: The method of specific example 17, wherein the representation of the set of media comprises an embedding of the media in a latent space, wherein the smart charger generates the embedding.

Specific example 19: The method of specific example 17, wherein the task prediction model comprises a generalized transformer model:

Specific example 20: The method of specific example 12, wherein the set of tasks is further determined based on a user profile generated from historic media received from the user device:

Specific example 21: The method of specific example 12, further comprising authenticating a user associated with the user device using a user credential, wherein the set of media is received in response to user authentication.

Specific example 22: A system comprising a smart charger, comprising: a user device connector; a wall plug; a control block wired to the user device connector and the wall plug, the control block comprising: an accessory authentication chip; a processing system configured to: register with a user device as an input-output (I/O) accessory; receive data from the user device after registration; determine a set of tasks based on the data; and control the user device to execute the set of tasks.

Specific example 23: The system of specific example 22, further comprising a remote computing system comprising a task prediction model, wherein the task prediction model predicts the set of tasks based on the data.

Specific example 24: The system of specific example 22, wherein the processing system further comprises a set of feature extraction models that extract features from the data, and wherein the set of tasks are predicted based on the extracted features.

Specific example 25: The system of specific example 24, wherein the data comprises a set of screenshots, wherein the set of feature extraction models comprises an object detector that identifies the features depicted within the set of screenshots.

Specific example 26: The system of specific example 22, wherein the processing system is further configured to determine a set of control inputs for each task of the set of tasks based on the data, wherein the processing system controls the user device using the set of control inputs to execute the respective task.

Specific example 27: The system of specific example 26, wherein the set of control inputs are predicted by a transformer model based on the respective task and the data.

Specific example 28: The system of specific example 22, wherein the smart charger further comprises a media conversion chip that converts the data from a user device format to a standard format.

Specific example 29: The system of specific example 22, wherein the smart charger further comprises a user authentication module, wherein the processing system is further configured to authenticate a user based on user signals received from the user authentication module, wherein the processing system registers with the user device as an I/O accessory in response to user authentication.

Specific example 30: The system of specific example 29, wherein the user authentication module comprises a biometric sensor arranged on the user device connector.

Specific example 31: The system of specific example 22, wherein the accessory authentication chip comprises a MFi chip.

Specific example 32: A charger comprising: a user device connector; the control block connected to the user device connector, the control block comprising: an accessory authentication chip, a media conversion chip, a processing unit connected to the accessory authentication chip and media conversion chip, wherein the processor is configured to: register the charger with a user device as an accessory using the accessory authentication chip; receive media from the user device after registration, using the media conversion chip; determine a set of responses based on the media, wherein the set of responses are predicted based on the user device media by a machine learning model, and control the user device based on the set of responses; and a power management circuit connected to the user device connector; and a power delivery mechanism connected to the power management circuit.

Specific example 33: The charger of specific example 32, further comprising a biometric sensor, and wherein the processing unit is further configured to: store a first biometric signal, receive a second biometric signal from the biometric sensor, compare the first biometric signal to the second biometric signal; and authenticate a user based on the comparison.

Specific example 34: The charger of specific example 32, wherein the accessory authentication chip is a Made for iPhone/iPad/iPod (MFi) chip.

Specific example 35: The charger of specific example 32, wherein the processing unit is configured to store and execute the machine learning model to predict the set of responses.

Specific example 36: The charger of specific example 32, wherein the machine learning model is executed by a remote computing system to predict the set of responses.

Specific example 37: The charger of specific example 32, wherein the charger excludes a display.

Specific example 38: The charger of specific example 32, wherein the power delivery mechanism comprises an onboard battery.

Specific example 39: The charger of specific example 32, further comprising a mechanical switch connected to the processing unit, wherein the processing unit is operable between: a media receipt mode when the mechanical switch is in a first position, wherein the charger receives media from the user device while providing electrical power to the user device; and a charging mode when the mechanical switch is in a second position, wherein the charger does not receive media from the user device when providing electrical power to the user device.

Specific example 40: The charger of specific example 32, wherein: the set of responses comprises a set of tasks, and the processing unit is further configured to execute the set of tasks on the user device.

Specific example 41: The charger of specific example 32, wherein the power delivery mechanism comprises a wall outlet plug.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken line in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A system comprising a smart charger, comprising:
a user device connector;
a wall plug;
a control block wired to the user device connector and the wall plug, the control block comprising:
an accessory authentication chip;
a processing system configured to:
register with a user device as an input-output (I/O) accessory;
receive data from the user device after registration;
determine a set of tasks based on the data; and
control the user device to execute the set of tasks.

2. The system of claim 1, further comprising a remote computing system comprising a task prediction model, wherein the task prediction model predicts the set of tasks based on the data.

3. The system of claim 1, wherein the processing system further comprises a set of feature extraction models that extract features from the data, and wherein the set of tasks are predicted based on the extracted features.

4. The system of claim 3, wherein the data comprises a set of screenshots, wherein the set of feature extraction models comprises an object detector that identifies the features depicted within the set of screenshots.

5. The system of claim 1, wherein the processing system is further configured to determine a set of control inputs for each task of the set of tasks based on the data, wherein the processing system controls the user device using the set of control inputs to execute the respective task.

6. The system of claim 5, wherein the set of control inputs are predicted by a transformer model based on the respective task and the data.

7. The system of claim 1, wherein the smart charger further comprises a media conversion chip that converts the data from a user device format to a standard format.

8. The system of claim 1, wherein the smart charger further comprises a user authentication module, wherein the processing system is further configured to authenticate a user based on user signals received from the user authentication module, wherein the processing system registers with the user device as an I/O accessory in response to user authentication.

9. The system of claim 8, wherein the user authentication module comprises a biometric sensor arranged on the user device connector.

10. The system of claim 1, wherein the accessory authentication chip comprises a MFi chip.

11. A charger comprising:
a user device connector;
the control block connected to the user device connector, the control block comprising:
an accessory authentication chip,
a media conversion chip,
a processing unit connected to the accessory authentication chip and media conversion chip, wherein the processor is configured to:
register the charger with a user device as an accessory using the accessory authentication chip;
receive media from the user device after registration, using the media conversion chip;
determine a set of responses based on the media, wherein the set of responses are predicted based on the user device media by a machine learning model, and
control the user device based on the set of responses; and
a power management circuit connected to the user device connector; and
a power delivery mechanism connected to the power management circuit.

12. The charger of claim 11, further comprising a biometric sensor, and wherein the processing unit is further configured to:
store a first biometric signal;
receive a second biometric signal from the biometric sensor;
compare the first biometric signal to the second biometric signal; and
authenticate a user based on the comparison.

13. The charger of claim 11, wherein the accessory authentication chip is a Made for iPhone/iPad/iPod (MFi) chip.

14. The charger of claim 11, wherein the processing unit is configured to store and execute the machine learning model to predict the set of responses.

15. The charger of claim 11, wherein the machine learning model is executed by a remote computing system to predict the set of responses.

16. The charger of claim 11, wherein the charger excludes a display.

17. The charger of claim 11, wherein the power delivery mechanism comprises an onboard battery.

18. The charger of claim 11, further comprising a mechanical switch connected to the processing unit, wherein the processing unit is operable between:
a media receipt mode when the mechanical switch is in a first position, wherein the charger receives media from the user device while providing electrical power to the user device; and
a charging mode when the mechanical switch is in a second position, wherein the charger does not receive media from the user device when providing electrical power to the user device.

19. The charger of claim 11, wherein:
the set of responses comprises a set of tasks, and
the processing unit is further configured to execute the set of tasks on the user device.

20. The charger of claim 11, wherein the power delivery mechanism comprises a wall outlet plug.
